(19) United States
(12) Patent Application Publication
(10) Pub. No.: US 2020/0372758 A1
(43) Pub. Date: Nov. 26, 2020

(54) GAMING SYSTEM AND METHOD OF PROVIDING PARTIAL REPLACEMENT OF OFFERED AWARDS

(71) Applicant: ADP GAUSELMANN GMBH, Espelkamp (DE)

(72) Inventors: Charles Hiten, Lighthouse, FL (US); Michael Charles Halvorson, Las Vegas, NV (US); Josef Alexander Hartl, Las Vegas, NV (US)

(21) Appl. No.: 16/992,990

(22) Filed: Aug. 13, 2020

Related U.S. Application Data
(63) Continuation of application No. 16/007,602, filed on Jun. 13, 2018, now abandoned.

(51) Int. Cl. G07F 17/32; G07F 17/34

(52) U.S. Cl. CPC G07F 17/3258; G07F 17/3213; G07F 17/34

(57) ABSTRACT

Various embodiments of a gaming system and method are disclosed as enabling replacements for one or more portions of an offered award. An offered award may comprise a plurality of different award values (e.g., portions of the offered award), where one or more of the plurality of award values can be selected for replacement in an attempt to improve the selected award values with larger award values. The gaming system may randomly generate replacement award values that are equal to zero, lower in value, equal in value, or greater in value than the award values selected for replacement. In other words, one or more portions of an offered award can be put at risk in attempt to improve the offered award.

### CROSS-REFERENCES TO RELATED APPLICATIONS

This application is a continuation of U.S. patent application Ser. No. 16/007,602, filed Jun. 13, 2018, the content of which is incorporated herein in its entirety.

### FIELD OF THE INVENTION

The present disclosure relates to gaming devices.

### BACKGROUND OF THE INVENTION

Gaming machines that accept wagers in exchange for the opportunity to win awards or prizes are known. Game machines that offer new ways to win awards or prizes are needed to gain and retain players' interest in the gaming machines.

### SUMMARY OF THE INVENTION

Various embodiments of a gaming system and method are disclosed as enabling replacements for one or more portions of an offered award. An offered award may comprise a plurality of different award values (e.g., portions of the offered award), where one or more of the plurality of award values can be selected for replacement in an attempt to improve the selected award values with larger award values. The gaming system may randomly generate replacement award values that are equal to zero, lower in value, equal in value, or greater in value than the award values selected for replacement. In other words, one or more portions of an offered award can be put at risk in attempt to improve the offered award.

In one embodiment with partial replacements of an offered award, a gaming system includes a plurality of symbol display areas associated with a plurality of video based slot machine reels. For example, the gaming system may include five video based slot machine reels that are each associated with three symbol display areas. The gaming system further includes a plurality of symbol sets that each includes a plurality of symbols, where each symbol set is associated with one of the slot machine reels. For a play of a game, for each slot machine reel, the gaming system generates a plurality of symbols from the associated symbol sets for the symbol display areas of the reel. The gaming system evaluates the generated plurality of symbols for winning symbol combinations. The gaming system determines a payout amount based on winning symbol combinations along wagered pay lines. The gaming system also evaluates the generated plurality of symbols for triggering symbol combinations. If the gaming system determines that a triggering symbol combination was generated, the gaming system starts a bonus game. A play of the bonus game may include a predetermined quantity of game spins (or activations) for the bonus game. In some embodiments, the predetermined quantity of spins are free spins. In some embodiments, the player may pay for the predetermined quantity of spins. It should be appreciated that in some embodiments without reels, the bonus game includes bonus game activations.

In some embodiments, the gaming system alters the play of the game during the bonus game. In some embodiments, the gaming system designates at least one symbol in each of the symbol sets as a persistent symbol during the bonus game. During the bonus game, the gaming system generates a plurality of symbols from the associated symbol sets for the symbol display areas of the reel for each of the predetermined quantity of spins. The gaming system evaluates the generated plurality of symbols for winning symbol combinations. If the gaming system generates and displays a persistent symbol in a particular symbol display area on a reel in any particular spin of the bonus game, the gaming system keeps the persistent symbol in the displayed symbol position for the duration of the remaining spins for the play of the bonus game. In one embodiment, the gaming system changes the pay table. In one embodiment, the persistent symbol is associated with a plurality of different values, but is disassociated from symbol combinations along a wagered pay line. In some embodiments, the gaming system randomly assigns one of the plurality of different values to a persistent symbol before, during, or after when the persistent symbol is generated and displayed in a particular symbol display area. In some embodiments, the persistent symbol values are awarded if two or more persistent symbols are generated and displayed directly adjacent to each other in the symbol display areas on the reels. That is, in some embodiments, to obtain the persistent symbol values as awards, a first persistent symbol must touch (or be adjacent) a second persistent symbol in a symbol display area that is directly above, directly to the left, directly to the right, or directly below the first persistent symbol to create a persistent symbol group. In some embodiments, the gaming system does not award a value associated with a persistent symbol when the persistent symbol is not touching at least one other persistent symbol in a symbol display area that is directly above, directly to the left, directly to the right, or directly below the first persistent symbol. In some embodiments, a predetermined quantity of persistent symbols must be in a persistent symbol group before the gaming system awards the values associated with the persistent symbols in the persistent symbol group. In some embodiments, any generated and displayed persistent symbol and its associated award value is part of a total award offered to the player. That is, in some embodiments, generated and displayed persistent symbols do not need to be in a persistent symbol group for the player to obtain the values associated with the generated and displayed persistent symbols. In some such embodiments, the pay table for the bonus game reduces or eliminates other symbol combinations that results in awards.

In one embodiment, the gaming system enables the player to risk one or more generated and displayed persistent symbols during the play of the bonus game. For example, the gaming system enables the player to select at least one of the generated and displayed persistent symbols for replacement after a spin of the bonus game. For a next spin of the bonus game, the gaming system will remove any generated and displayed persistent symbol that was selected and generate a plurality of symbols from the associated symbol sets for the symbol display areas of the reels. When the selected persistent symbols are removed, the gaming system can possibly generate new persistent symbols for symbol display areas associated with removed persistent symbols. The newly generated persistent symbols may be associated with award values that are higher than award values associated with the removed persistent symbols. However, gaming system may also generate new persistent symbols associated with award values that are equal to or lower than award values associated with the removed persistent symbols. In some embodiments the game machine may not generate any new persistent symbols in place of the removed persistent symbols. Thus, the player can risk one or more portions of an award offer (one or more award values associated with displayed persistent symbols) for a chance to improve the award offer, without risking the entire award offer.

In one embodiment, the gaming system restricts the player from selecting displayed persistent symbols for removal until one spin of the bonus game remains. In some embodiments, the gaming system enables the player to select displayed persistent symbols for removal after each spin of the bonus game (until one spin remains in the bonus game). In some embodiments, the player must pay (or place a wager) for the right to select persistent symbols for removal during the bonus game. In some embodiments of the bonus game, the gaming system offers the player the ability to select displayed persistent symbols for removal for a fee (or a wager) after the last spin of the bonus game.

In some embodiments, different purchase or wager levels may unlock the ability to select different quantities of displayed persistent symbols during a play of the game. In some such embodiments, a first symbol display area to receive a replacement persistent symbol may be associated with a higher award value than an award value associated with a second symbol display area to receive a replacement persistent symbol. The gaming system may offer the player a chance to purchase (or wager on) the ability to select and remove persistent symbols at the start of the play of the game, during the play of the game (including during the bonus game), or after all of the spins have been used during a play of the bonus game. The wager to select and remove persistent symbols at the start of the play of the game is lower in some embodiments, than a wager to select and remove persistent symbols made during the play of the game.

By enabling the player to risk portions of an offered award and provide players with some control over the player's offered award, the gaming system reduces potential player disappointment with game outcomes and enhances player excitement for a game. The new potential to improve or earn greater awards without risking an entire offered award creates a greatly improved sense of anticipation for players.

### BRIEF DESCRIPTION OF THE DRAWINGS

FIG. 1 is a perspective view of one embodiment of a stand-alone gaming device of a gaming system.

FIG. 2 is a functional block diagram of the gaming device technology components of the gaming system.

FIGS. 3A, 3B, 3C, and 3D illustrate one embodiment of a method of operating the gaming system enabling a player to risk portions of an offered award and attempt to improve the offered award.

FIGS. 4A, 4B, 4C, 4D, 4E, 4F, 4G, 4H, 4I, 4J, and 4K illustrate screen shots of one embodiment of a gaming system enabling a player to risk portions of an offered award and attempt to improve the offered award.

FIG. 5 and FIG. 6 illustrate embodiments of pay tables in a gaming system having improvements to game outcomes with near misses.

### DETAILED DESCRIPTION OF THE INVENTION

Various embodiments of a gaming system and method are disclosed as enabling replacements for one or more portions of an offered award. An offered award may comprise a plurality of different award values (e.g., portions of the offered award), where one or more of the award values can be selected for replacement in an attempt to improve the selected award values with larger award values. The gaming system may randomly generate replacement award values that are equal to zero, lower in value, equal in value, or greater in value than the award values selected for replacement. In other words, one or more portions of an offered award can be put at risk in attempt to improve the offered award.

In various embodiments, the gaming system enables the player to risk portions of an offered award to improve game awards in base games, bonus games, or both.

In one embodiment with partial replacements of an offered award, a gaming system includes a plurality of symbol display areas associated with a plurality of video based slot machine reels. For example, the gaming system may include five video based slot machine reels that are each associated with three symbol display areas. The gaming system further includes a plurality of symbol sets that each includes a plurality of symbols, where each symbol set is associated with one of the slot machine reels. For a play of a game, for each slot machine reel, the gaming system generates a plurality of symbols from the associated symbol set for the symbol display areas of the reel. The gaming system evaluates the generated plurality of symbols for winning symbol combinations. The gaming system determines a payout amount based on winning symbol combinations along wagered pay lines. The gaming system also evaluates the generated plurality of symbols for triggering symbol combinations. If the gaming system determines that a triggering symbol combination was generated, the gaming system starts a bonus game. A play of the bonus game may include a predetermined quantity of spins (or activations) for the bonus game. In some embodiments, the predetermined quantity of spins are free spins. In some embodiments, the player may pay for the predetermined quantity of spins. It should be appreciated that in some embodiments without reels, the bonus game includes activations.

In some embodiments, the gaming system alters the play of the game during the bonus game. In some embodiments, the gaming system designates at least one symbol in each of the symbol sets as a persistent symbol during the bonus game. During the bonus game, the gaming system generates a plurality of symbols from the associated symbol sets for the symbol display areas of the reel for each of the predetermined quantity of spins. The gaming system evaluates the generated plurality of symbols for winning symbol combinations. If the gaming system generates and displays a persistent symbol in a particular symbol display area on a reel in any particular spin during the bonus game, the gaming system keeps the persistent symbol in the displayed symbol position for the duration of the remaining spins of the bonus game. In one embodiment, the gaming system changes the pay table. In one embodiment, the persistent symbol is associated with a plurality of different values, but is disassociated from symbol combinations along a wagered pay line. In some embodiments, the gaming system randomly assigns one of the plurality of different values to a persistent symbol before, during, or after when the persistent symbol is generated and displayed in a particular symbol display area. In some embodiments, the persistent symbol values are awarded if two or more persistent symbols are generated and displayed directly adjacent to each other in the symbol display areas on the reels. That is, in some embodiments, to obtain the persistent symbol values as awards, a first persistent symbol must touch (or be adjacent to) a second persistent symbol in a symbol display area that is directly above, directly to the left, directly to the right, or directly below the first persistent symbol to create a persistent symbol group. In some embodiments, the gaming system does not provide a player with an award value associated with a persistent symbol when the persistent symbol is not touching at least one other persistent symbol in a symbol display area that is directly above, directly to the left, directly to the right, or directly below the persistent symbol. In some embodiments, a predetermined quantity of persistent symbols must be in a persistent symbol group before the gaming system awards the values associated with the persistent symbols in the persistent symbol group. In some embodiments, any generated and displayed persistent symbol and its associated award value is part of a total award offered to the player. That is, in some embodiments, generated and displayed persistent symbols do not need to be in a persistent symbol group for the player to obtain the values associated with the generated and displayed persistent symbols. In some such embodiments, the pay table for the bonus game reduces or eliminates other symbol combinations that results in awards (other than award values associated with persistent symbols).

In one embodiment, the gaming system enables the player to risk one or more generated and displayed persistent symbols during the play of the bonus game. For example, the gaming system enables the player to select at least one of the generated and displayed persistent symbols for replacement after a spin of the bonus game. For a next spin of the bonus game, the gaming system will remove any generated and displayed persistent symbol that was selected and generate a plurality of symbols from the associated symbol sets for the symbol display areas of the reels. When the selected persistent symbols are removed, the gaming system can possibly generate new persistent symbols for symbol display areas associated with removed persistent symbols. The newly generated persistent symbols may be associated with award values that are higher than award values associated with the removed persistent symbols. However, gaming system may also generate new persistent symbols associated with award values that are equal to or lower than award values associated with the removed persistent symbols. In some embodiments the game machine may not generate any new persistent symbols in place of the removed persistent symbols. Thus, the player can risk one or more portions of an award offer (one or more values associated with displayed persistent symbols) for a chance to improve the award offer, without risking the entire award offer.

In one embodiment, the gaming system restricts the player from selecting displayed persistent symbols for removal until one spin of the bonus game remains. In some embodiments, the gaming system enables the player to select displayed persistent symbols for removal after each spin of the bonus game, until one spin remains in the bonus game (e.g., the player cannot select displayed persistent symbols for removal after the last spin of the bonus game because no spins remain). In some embodiments, the player must pay for (or wager on) the right to select displayed persistent symbols for removal during the bonus game. In some embodiments of the bonus game, the gaming system offers the player the ability to select displayed persistent symbols for removal for a fee or wager after the last spin of the bonus game.

In some embodiments, different purchase or wager levels may unlock the ability to select different quantities of displayed persistent symbols during a play of the game. In some such embodiments, a first symbol display area to receive a replacement persistent symbol may be associated with a higher award value than an award value associated with a second symbol display area to receive a replacement persistent symbol. The gaming system may offer the player a chance to purchase the ability to select and remove persistent symbols at the start of the play of the game, during the play of the game (including during the bonus game), or after all of the spins have been used during a play of the bonus game.

### Gaming System Platform

The features and advantages of the gaming system and method described herein may be provided to a player via a gaming device platform that includes various structures and components for allowing player interaction with the gaming device. While only one gaming device platform will be described in detail herein, the features, objects, and advantages of the gaming system described herein may be implemented in one or more alternative gaming device platforms.

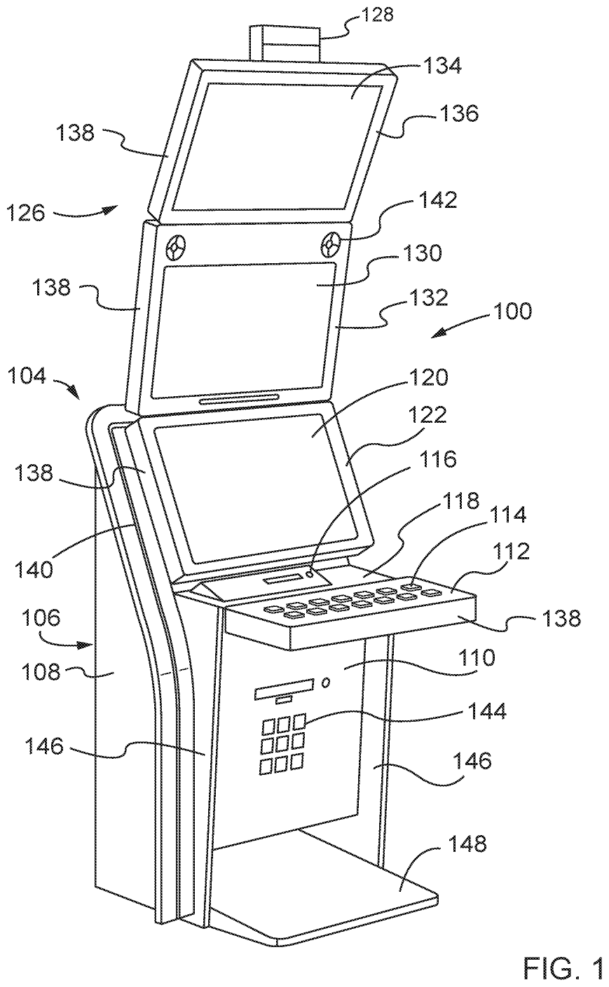

One embodiment of a gaming device platform is shown in FIG. 1 where a gaming device 100 is generally shown. In one embodiment, the gaming device 100 is referred to as a slot machine and is illustrated as housed in a housing or cabinet constructed so that a player can operate and play the gaming device 100 while standing or sitting.

Gaming device 100 may include cabinet 104 for housing the components fully described hereinbelow. The cabinet 104 has a lower cabinet body portion 106 which includes a pair of cabinet side panels 108 (only one of which is viewable in the perspective view of FIG. 1), front panel 110, and a rear panel (not shown). A base panel (not shown) and a top panel surface (not shown) that supports first game display 120 and the player interaction area 112, are provided. The cabinet panels are interconnected along their edges and cooperate to form a cabinet enclosure for housing the gaming device, as can be seen in FIG. 1.

It should be appreciated that a wide variety of cabinet enclosure sizes, shapes, and designs are possible for the gaming device 100. Cabinet 104 may function to securely protect any local control system, technology components, and provide support for game display(s) and player input and output interactions with the gaming device.

Returning to FIG. 1, the gaming device enables the player to interact with the gaming device 100 to direct the wagering and game play activities and preferences. Various forms of player interaction devices and activities will now be described.

Cabinet 104 includes a player interaction area having input and output areas generally designated as 112. The player interaction area 112 may be located on the front top side of cabinet 104 and, as shown, on a panel structure that extends outwardly from the gaming device in a player's direction. Player interaction area 112 may contain a plurality of player input and output structures such as player control button area 114, player value acceptor and dispenser area 116, and player convenience input area 118.

Player control button area 114 includes a plurality of buttons, touch sensitive areas, or both through with which players may interact with the one or more processors of gaming device 100 and direct game play. It is expected that cabinet 104 provides an easily accessible location and support for all necessary player input/output (I/O) interactions with the device, including gaming control interactions and value wagering interactions. Although the gaming device 100 illustrated in FIG. 1 shows player controls provided by buttons of player control button area 114, it is understood that in one embodiment, a player's gaming control interactions could be made by either buttons mounted on cabinet 104 or “soft” buttons located on the gaming display and activated by player touch (e.g., touch screen interfaces), or a combination of both arrangements.

Player control button area 114 may include, for example: game selection button(s) in any embodiments where more than one game is provided in a single gaming device; gaming denomination value selection button(s) in any embodiments where one or more wagering denomination value is accommodated; wager selection button(s) for the player to indicate or select the desired wager value for a game in any embodiments where a selection of wager values are offered; pay line selection button(s) for selecting the number of active pay lines in game embodiments that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information. As discussed above, the functions of the buttons in player control button area 114 may be duplicated with soft buttons in the player control button area 114 or as soft buttons in other areas of the gaming device 100 (e.g., as a touch screen overlay over available game displays).

Gaming device 100 may include one or more forms of value acceptance and value distribution to allow the player to interact with the device and to risk or otherwise place a wager (a monetary value) on one or more outcomes of a game. Winnings may be returned to the player via some form of value distribution. As illustrated in FIG. 1, player value acceptor and dispenser area 116 is provided. In the player value acceptor and dispenser area 116, a player supplies monetary value to the gaming device 100 via one or more value acceptor devices. In one embodiment, the player value acceptor and dispenser area 116 (through the one or more value acceptor devices) may accept any one or more of the following from a player to establish a gaming credit balance: coins, bills, tokens, tickets/vouchers, player ID cards, credit cards, or other suitable forms of value. Thus, if the gaming device 100 accepts coins and bill, the gaming device 100 includes a currency bill validator and a coin validator as the value acceptor devices. Likewise, if the gaming device 100 accepts tickets, the gaming device includes a ticket acceptor as a value acceptor device for receiving tickets or vouchers representing some monetary value. The ticket acceptor may include a bar code reader, or other appropriate code reader, for reading the encoded value contained by the player's ticket or voucher. In some embodiments, the player value acceptor and dispenser area 116 may include a value acceptor device that can accept more than one type of value. In some embodiments, the player value acceptor and dispenser area 116 may include multiple different value acceptor devices to accept different types of value from players

Upon receipt of some type of value from the player, a value acceptor device of the player value acceptor and dispenser area 116 performs validation on the player supplied value using appropriate hardware readers (e.g., determining that the currency bills/coins/tokens are genuine or the ticket/voucher is genuine). If the validation result is positive on player supplied value, the appropriate value acceptor device generates a signal to a processor of the gaming device 100 to establish a gaming credit balance for plays of one or more games on gaming device 100.

In one embodiment, a player receives monetary value, or a representation thereof, from the gaming device 100 when a player chooses to “cash out” the gaming credit balance (e.g., remove value from the gaming device 100). The player can cash out at any suitable time. When a player cashes out the value contained on a credit meter (not shown) of gaming device 100, a processor of gaming device 100 may cause a printer of gaming device 100 to print and dispense a coded ticket or voucher through a dispensing slot to the player. The coded ticket or voucher may be a bar-coded ticket or any other suitable code (PDF417 coding or quick response (QR) coding). This ticket can then be used as value input at another gaming device, or converted to currency at a conveniently located kiosk or cashier counter located near the gaming device. Alternatively, the processor of gaming device 100 may cause a currency bill dispenser or a coin dispenser in gaming device 100 to dispense the value contained on the credit meter of gaming device 100.

Various combinations of the above value acceptance and value distribution arrangements are possible. Gaming device 100 may include other value acceptance and value distribution mechanisms in the player value acceptor and dispenser area 116. For example, gaming device 100 may include a magnetic strip or chip card reader/writer in order to accept value from and transfer value to a magnetic strip or an embedded chip card. In other embodiments, hardware for transferring (and receiving) non-traditional currencies to players such as digital currencies (e.g., bitcoin) may be included in gaming device 100.

In an alternative embodiment, gaming device 100 may include a card reader (not illustrated) in the in the player value acceptor and dispenser area 116, which accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming device may be associated with the player account. It is noted that a numeric or alphanumeric keypad may be provided adjacent to the card reader slot to enable player entry of a personal identification number or the like for secure access to card information.

In one embodiment, a player convenience input area 118 may be included in the gaming device 100, as is shown in FIG. 1. In various embodiments, player convenience input area 118 may have a variety of features and functions depending on the jurisdictional deployment of the gaming device 100. In one embodiment, the player convenience input area 118 will house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into a gaming device during play. These player loyalty/player tracking cards are associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain embodiments, the player convenience input area 118 may include player convenience features such as a pocket for storage that allows players to store their personal items such as a mobile phone. Gaming device 100 may include one or more universal serial bus (USB) ports that enables a player to charge their electronics or connect to services such as the Internet or food service. Further, player convenience input area 118 of gaming device 100 may include buttons to request food or drink service if the gaming device is located in an establishment that has food and drink service. The gaming device 100 may be connected to a local or wide area network such that selection of the requested food or drink service will alert the establishment's hospitality staff to deliver the requested service directly to the gaming device 100.

The layout of the player control button area 114, player value acceptor and dispenser area 116 and the player convenience input area 118 in gaming device 100 may be arranged differently than those disclosed and illustrated herein. The selections and arrangement of input locations on the cabinet 104 may be dependent upon the game buttons, the type of value wagered, and the player conveniences utilized in the deployment configuration of gaming device 100.

With continuing reference to FIG. 1, in one embodiment, lower cabinet body portion 106 includes a first game display 120 mounted atop or flush with the lower cabinet body portion's top panel surface. First game display 120 is, for example, a 27-inch liquid crystal display (LCD) display mounted in a widescreen orientation. However, any suitable display may be used in any suitable orientation. In the illustrated embodiment, the first game display 120 is mounted within and framed by first display frame 122 which is, in turn, mounted upon lower cabinet body portion's top panel surface. In this manner, the first game display 120 is both surrounded and secured within the first display frame 122 and raised above the cabinet's top panel surface. Additional features of the first display frame 122 will be described below. In one embodiment, gaming device 100 may use one first game display 120 and not include additional game displays (not illustrated).

The lower cabinet body portion 106 is further constructed to support upper cabinet portion 126. Upper cabinet portion 126 may be comprised of an upwardly extending support structure (not illustrated) that extends upwardly from the rear side of lower cabinet body portion 106 and is sufficiently strong to support one or more additional game displays.

At the topmost end of the support structure, a cabinet top light 128 may be provided. The cabinet top light 128 is capable of illumination in a variety of colors and is utilized to indicate and communicate gaming device conditions to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In one embodiment, as illustrated in FIG. 1, gaming device 100 includes two additional displays, second game display 130 and third game display 134. Second game display 130 and third game display 134 are disposed generally in a vertical relationship and generally in alignment with the first game display 120. Like the first game display 120, second game display 130 and third game display 134 can be 27-inch LCD displays and can be mounted in a widescreen orientation in one embodiment. However, any suitable display in any suitable orientation may be used for the second game display 130 and the third game display 134. Further, like the first game display 120, second game display 130 and third game display 134 can be mounted within and framed by second display frame 132 and third display frame 136, respectively. Second display frame 132 and third display frame 136 are attached to the upper cabinet support structure and can protect the second game display 130 and the third game display 134.

First game display 120, second game display 130, and third game display 134 can be disposed at an angle from each other to form a player-facing concave arc. However, in some embodiments, the angles between the displays may be adjustable and may be smaller or greater than the angles illustrated in FIG. 1. Further, it is understood that in some embodiments the displays may be disposed in a common plane relative to each other.

It also should be appreciated that in various embodiments a variety of display technology may be utilized equivalently and interchangeably with a variety of embodiments of the gaming device. Equivalent display devices include all variations of liquid crystal displays, light emitting diode displays, and plasma displays.

In some embodiments, different sized displays may be combined to display gaming data on gaming device 100. As a non-limiting example, a 27-inch widescreen LCD display may be combined with a 20-inch portrait oriented LCD or a light emitting diode (LED) display. This combination may be used, for example, with a third scrolling banner LED display. In alternative embodiments, one, two, three, or more displays could be used in a variety of positions and orientations. Any suitable combination may be used. It should also be appreciated that a processor of gaming device 100 may communicate with the disclosed first game display 120, second game display 130, and third game display 134 through a video card of gaming device 100 to produce the visible aspects of a game.

In one embodiment, one or more of the first game display 120, second game display 130, and third game display 134 may be fitted with a transparent touch sensitive overlay for sensing player touch inputs into the gaming device. Touch sensitive overlays can communicate with a processor of gaming device 100 to enable the player to interact with the game.

In some embodiments, the curved displays may be used for any or all of the first game display 120, second game display 130, or third game display 134. Similarly, any of the displays used for gaming device 100 can be based on flexible display technologies. For example, it is possible to utilize flexible display technologies to create uniquely shaped curving, wavy, or tubular display structures to provide one or more of the first game display 120, second game display 130, and third game display 134. Additionally, in one embodiment flexible display technologies can be used in combination with fixed flat screen technologies.

While the gaming device 100 has been described as implemented with video technologies, in one embodiment, mechanical reels with reel strips containing game indicia and step motor controllers may be employed to provide game information to a player. In one embodiment, the reel strips may include a plurality of printed symbols. In another embodiment, the mechanical reels may include flexible video display technology as the reel strips on mechanical reels. Thus, games implemented in video form can readily be implemented with mechanical reels utilizing such display technology. Alternatively, in other embodiments mechanical reels with reels strips having fixed symbols displayed along the reel strip could be used to implement the game.

Dependent upon the particular gaming device housing style, a variety of other display technologies may be utilized in combination with the gaming device disclosed herein. For example, in some embodiments a gaming device may have one or more display devices in addition to the main game display(s). For example, the gaming device may include a player tracking device having a player tracking display which displays various information to the player regarding the player's status. The gaming device may also include other game-related displays such as the wager display and the gaming credit balance display. These additional game-related displays may be separate display devices or may be displayed on any one or more of the first game display 120, the second game display 130, or the third game display 134.

Cabinet lighting design functions to attract players to a gaming device 100. In the embodiment of FIG. 1, attractive cabinet lighting is provided by frame accent lighting 138. It is noted that frame accent lighting 138 is a common structure found on each of the first display frame 122, the second display frame 132, and the third display frame 136 and player interaction area 112. Example areas where frame accent lighting is applied to gaming device 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces 138. In one embodiment, the circuit boards are flexible circuit boards. These LED strips and transparent or translucent coverings may surround one or more gaming device displays frames, as well as the player interaction area, to highlight these areas.

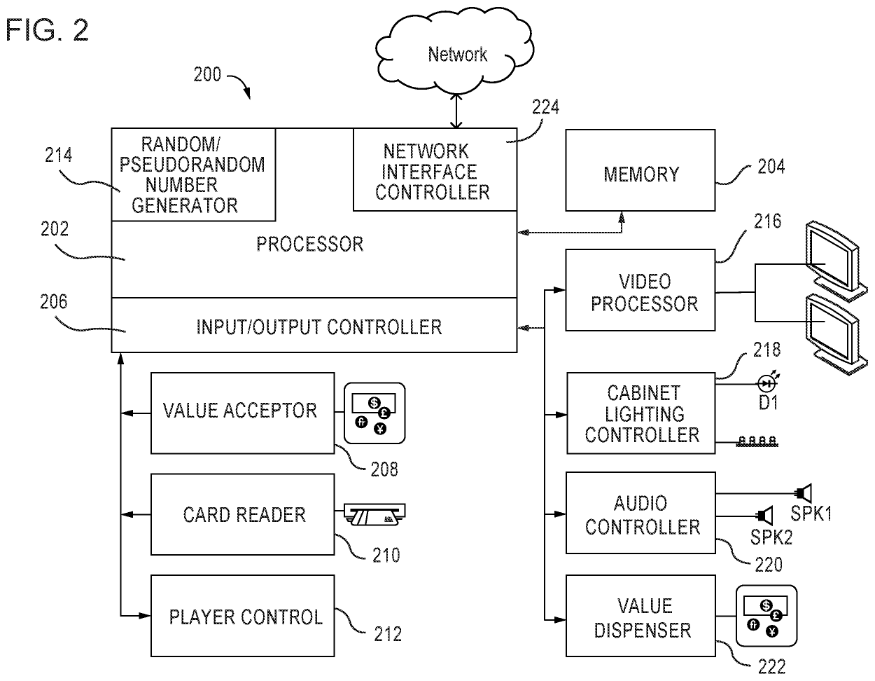

In one embodiment, the individual LEDs mounted on the LED strips are of a type that can emit red, green, and blue light. In an alternative embodiment, separate LEDs are used for each required light color. All LED strips can be electrically connected and can be controlled by a cabinet lighting controller 218 (illustrated in FIG. 2) in conjunction with a processor of gaming device 100 to selectively mix the emitted light colors in a manner to create any color. The cabinet lighting controller 218 can flash and vary lighting as desired. For example, cabinet edge lighting can change and flash in combination with music rhythms or in combination with game events. Other variations are possible.

In some embodiments, cabinet 104 may include LED strip lighting or LED rope lighting to accentuate the cabinet and enhance the attractiveness of gaming device 100 to players. LED rope lighting is a plurality of small light-emitting diode bulbs linked together and encased in a plastic, polyvinylchloride, or other suitable material to create a string of lights. For example, in the embodiment of FIG. 1, cabinet 104 includes cabinet accent lighting 140. In one embodiment, cabinet accent lighting 140 is LED rope lighting mounted flush with the front side edge of the cabinet side panels 108. The LED rope lighting can generate any of suitable colors, and are controlled by cabinet lighting controller 218 and a processor of gaming device 100 to selectively mix the emitted light colors in a manner to create any color in the same manner as the frame edge lighting.

In various embodiments, gaming device 100 includes one or more audio speakers and appropriate driving electronics and sound cards so that game players may experience pleasing audio aspects of the gaming device 100. Audio is desirable to attract and maintain player interest in gaming device 100. Gaming device 100 may also emit attraction sounds during any idle period of gaming device 100. Game audio may add to the player's enjoyment of gaming device 100 by providing music and sound effects designed to enhance and compliment the gaming experience.

Audio speaker hardware may include one or more speakers disposed in or on the cabinet 104 of gaming device 100. In FIG. 1, a pair of audio speakers 142 are shown mounted on the upper corners of second display frame 132. Any suitable number of additional speakers may be provided on additional display frames or on the lower cabinet body portion 106 as desired.

Speakers designed for emitting bass vibrations may be included in some embodiments. Speaker placement may be selected to enhance the sound emitting characteristics of the gaming device. For example, bass speakers or additional speakers 144 may be mounted inside lower cabinet body portion 106. Further, it is envisioned that in some embodiments sound processing such as multichannel processing and surround sound processing are included in gaming device 100. Audio jacks for attachment of player headphones may also be provided in some embodiments of gaming device 100 for the player to further enhance the audio experience of the game and also to block out noise from other gaming devices.

In one embodiment, front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 146 which serve to define a space below player interaction area 112 for players to place their feet and legs while they are playing gaming device 100 in a seated position. Foot rest 148, which may be cushioned, is provided below player interaction area 112 to enhance a player's ergonomic comfort while playing gaming device 100. In one embodiment, the edges of player interaction area 112 may be ergonomically cushioned as well.

Gaming device 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 104 which can comprise a variety of shapes, sizes, and forms. The cabinet 104 can 1) protect and house the operational electronics, 2) adequately support the display(s) in a position easily viewable for a seated or standing player, as necessary 3) provide an easy location and support for all necessary player input/output (I/O) interactions, including gaming control interactions and value wagering interactions. For example, in some embodiments the gaming device 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In one embodiment, housing styles of cabinet 104 of gaming device 100 may include bar top or table top housing arrangements. These housings are generally small enough to be placed on top of an existing bar or table while providing the requisite gaming device housing functions of protection of/access to gaming electronics, displays, and player I/O functions described above.

In one embodiment, cabinet 104 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

Turning now to FIG. 2, the features and advantages of the gaming system described above will now be described in terms of the various technology components for allowing player interaction with the gaming device 100.

FIG. 2 illustrates a functional block diagram of an embodiment of technology components of gaming device 100 that are specially configured to carry out the game function and operations described herein. The functional elements shown in FIG. 2 cooperate, on a broad and general level, to function as gaming device 100. The subject matter and functional operations described in relation to FIG. 2 can be embodied in hardware, software, or a combination thereof. Described hardware includes the structures described and their functional or operational equivalents. Described functions may be performed by hardware, digital circuitry, computer software, computer firmware, or functionally equivalent combinations thereof.

In one embodiment, gaming device 100 is functionally controlled by control unit 200. Control unit 200 is specifically configured and functions to perform all aspects of operations for providing the game. Control unit 200 includes at least one specially configured processor and at least one controller configured to operate with at least one memory device and at least one data storage device, at least one input device, and at least one output device. In one embodiment, control unit is also configured to communicate with a server device through a network.

In one embodiment, control unit 200 includes at least one specially configured processor 202 or central processing unit (CPU). In one embodiment, specially configured processor 202 include arithmetic logic units and math co-processors also known as floating point units. In one embodiment, specially configured processor 202 includes registers for holding instructions or other data, and cache memory for storing data for faster operation thereupon. In one embodiment, specially configured processor 202 may be a multi-core processor that includes two or more processors for enhanced performance, more efficient parallel processing, or other advantageous computing functions. In another embodiment, specially configured processor 202 may be one or more processing devices such as microprocessor(s) or integrated circuit(s) and may include one or more controllers. It should be appreciated that in some embodiments, a general purpose processor could be programmed to perform the functions of specially configured processor 202.

A controller, in one embodiment, is a device or a software program that manages or directs the flow of data between two entities. Often, controllers are special purpose circuitry or software that solve a technical communications problem between different technology systems. In one embodiment, a controller functions as an interface between two systems while managing the communications between the systems. In another embodiment, a controller functions as an interface between a processor and a peripheral device and functions to control the peripheral device.

At least one specially configured processor 202 or controller of control unit 200 is specially configured to communicate with at least one memory device, generally shown as memory device 204 in FIG. 2. In one embodiment, memory device 204 includes one or more memory structures for storing instructions and various types of game data. Memory structures include one or more random access memory units (RAMs) units, one or more read only memory units (ROMs), one or more flash memory units including solid state drives (SSDs), one or more electrically erasable/programmable read only memory units (EEPROMs).

It should be appreciated that in one embodiment, communication with a memory device by a processor or a controller encompasses the processor or controller accessing the memory device, exchanging data with the memory device, or storing data to the memory device.

Memory device 204 may store all program code and game code (collectively the “code”), and operation data necessary for the operation of the gaming device 100 and execution of the gaming features described hereinbelow. In an alternative embodiment, game code and operation data necessary for the operation of the gaming device 100 may be store in a distributed manner such that some code is stored in memory device 204 and other code is stored remotely from gaming device 100. In one embodiment, the code and operation data necessary for the operation of the gaming device includes, for example, basic input and output function data, instruction fetching data, bus and network communication protocol data, and like data necessary for an operational gaming device 100. In one embodiment, the code and operation data necessary for the execution of the gaming features includes, for example, game image data, game rule data, pay table data, game mode and timing data, gaming value and wager parameter data, and random or pseudo-random number generation data.

In addition to the memory device 204 described above, in one embodiment, the code and operation data for the operation of the gaming device described above may be stored in removable game cartridges or flash drives, a compact disk ROM, a digital versatile disk (DVD) optical storage technology, or suitable other fixed non-transitory storage mediums. In another embodiment, part or all of the code and operational data for operation of the gaming device or for execution of the game features may be stored in a remote memory structure and be downloaded to the memory device 204 via a network connection.

In one embodiment, the gaming device 100 may utilize any combination of memory devices such as random access memory devices (RAMs), unalterable memory devices (ROMs), and mass storage devices for securely storing and securely communicating the software components or code that facilitate game play and other functions of the gaming device 100. The memory devices may store software components or code that include various game data and game related control and execution software. In some embodiments, the software components stored in the memory devices may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the gaming device 100.

In some embodiments, the memory devices, such as memory device 204, with the software components and other data may be secured and authenticated by authentication software stored in an unalterable memory device within the housing of gaming device 100. The gaming device 100 may also include application specific integrated circuits (ASICs) to perform the security and authentication functions. At any appropriate time, such as before each play of a game, at a predetermined interval, upon transfer of any game data or any software components from a mass storage to memory device 204, or upon demand, the gaming device 100 (using a processor such as processor 202 or a separate ASIC) may execute an authentication routine and perform an authentication of any software component or other data of the gaming device 100. In one embodiment, the gaming device software components may be prepared for authentication via creation and storage of an encrypted signature unique to one or more of the software components.

In one embodiment, an encrypted signature may be created by utilizing a hash function on a software component or code to form a message digest (i.e., a hash of the software component) followed by a key encryption of the message digest to form an encrypted signature unique to the software component. In some embodiments, the key encryption may be public key encryption, private key encryption, or any suitable key encryption schema. The encrypted signature may be stored with the gaming device software component, for example, in a mass storage device or an unalterable memory. During a software component authentication, the gaming device 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and gaming device 100 may allow game play to proceed. However, when the message digests do not match, the gaming device 100 may determine that the software component under authentication may be corrupted or fraudulent and game play may be halted. It should be appreciated that the gaming device 100 may perform other suitable security and authentication checks on the game data or software components. Such authentication and security devices and functions are unique to gaming and casino industry to minimize or prevent fraud in gaming devices and gaming systems.

For a player to interact with gaming device 100, control unit 200 receives and processes player inputs, and control unit 200 causes processed results to be output or communicated to the player. In one embodiment, player inputs are recognized and processed or directed for processing by input/output (I/O) controller 206. Further, I/O controller 206 may process and direct player outputs for communication to the player. I/O controller 206 can function as the intermediary between the specially configured processor 202 and one or more input devices to control information and data flow therebetween. I/O controller 206 may also function as the intermediary between the specially configured processor 202 and one or more output devices to control information and data flow therebetween. I/O controller 206 is configured to understand the communication and operational details (such as hardware addresses) for each attached input device and output device. In this manner, specially configured processor 202 is freed from the operational details of the peripheral I/O devices. For example, in one embodiment where an input or output device is changed or upgraded, I/O controller 206 can be changed without changing other gaming system 100 components.

In one embodiment, a player deposits value into gaming device 100 by inserting some form of currency into a value acceptor 208 for game play. Alternatively, a player deposits value into gaming device 100 by inserting an encoded paper ticket into a value acceptor 208 for game play in one embodiment. Value acceptor 208 can be combined with a currency reader and validator, and a code reader for reading value encoded on paper tickets. Value acceptor 208 may read, validate and communicate the amount of the inserted value to the specially configured processor 202. Specially configured processor 202 can establish a gaming credit balance for the player based on the communication from the value acceptor 208. Specially configured processor 202 can also communicate the player's credit balance on a credit balance display of gaming device 100. During game play, each time a player risks a wager on an outcome, specially configured processor 202 processes the wage and determines the amount of credits to debit from the player's credit balance. When a winning outcome is obtained, specially configured processor 202 is configured to determine the amount of credits to add to the player's credit balance.

As previously mentioned with respect to FIG. 1, a variety of value acceptance arrangements are possible. In one embodiment, the value acceptor 208 could include magnetic strip or chip card readers to accept and transfer value. Value acceptor 208 may also be configured to accept and transfer non-traditional currencies such as digital currencies. In these embodiments, I/O controller 206, a specially configured processor 202, or both contain appropriate control instructions to communicate and extract value from the inserted item containing value. In one embodiment, use of a magnetic strip or embedded chip card, for example a bank card, for value insertion requires specially configured processor 202 to communicate, via network interface controller 224 (described below), with devices external to the gaming device 100.

In one embodiment, card reader 210 may be included in gaming device 100 to accept player loyalty cards. For example, card reader 210 can extract account identifying information from the card and utilizes this information to access the associated account information stored remotely via network interface controller 224. In embodiments where player loyalty/player tracking systems are employed, a player's loyalty account and record of gaming activity can be stored in a networked storage location or database. Specially configured processor 202 is configured to record the player's gaming activity in memory device 204 during the duration of loyalty card insertion. When the loyalty card is removed from card reader 210, recorded gaming activity is uploaded, via network interface controller 224, to the remote storage location associated with the player's account. In this manner, the player's gaming activity can be further processed and analyzed, and the player can be awarded loyalty rewards based upon his activity data.

In various embodiments, player control 212 receives a player's game inputs and communicates the player's game inputs to specially configured processor 202. The player's game inputs may include, but are not limited to, wager amounts, pay line selections, game control signals, and cash-out signals. The player control 212 may generate signals based on button presses, touch screen activations, or voice control. The player initiated signals are propagated to the specially configured processor 202 by I/O controller 206. Further, the player initiated signals may direct and inform execution of the game instructions stored in memory device 204 and configured to be executed by specially configured processor 202.

In one embodiment, specially configured processor 202 is configured to execute stored program code and instructions which generate random numbers or pseudo-random numbers. In one embodiment, as illustrated in FIG. 2, a random number generator (RNG) 214 is a software module configured to be executed by specially configured processor 202 for the generation of a true random or pseudo-random number. The code for RNG 214 may be stored in memory device 204. RNG 214 generates random numbers for use by the gaming software during game execution. In one embodiment, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various embodiments, once random symbols are selected based upon the random number generated by RNG 214, patterns of symbols are compared to determine wagering outcomes. In an alternative embodiment, gaming device 100 may include a hardware based random number generator that is in communication with specially configured processor 202 to supply random numbers for game generation purposes. The hardware based random number generator may be incorporated into specially configured processor 202 or can be separate from specially configured processor 202.

In yet another embodiment, random generation of “numbers” or symbols may be performed with electro-mechanical components. For example, gaming devices such as gaming device 100 may incorporate a plurality of mechanical reels rotatable about a common axis. A plurality of indicia or symbols may be positioned around the periphery of the plurality of reels. Each of the indicia or symbols on each reel may indicate separate detectable reel stop positions. The reels can be set into a spinning/rotation motion by pulling a lever or pushing a button. In some embodiments, the gaming device 100 can stop the reels by the gaming device 100 actuating, on a random timing basis, a suitable mechanical or electro-mechanical reel brake. When the reels stop rotating, one or more displayed stop positions of each reel is detected. Since the stop positions are each associated with an indicia or symbol, the gaming device can determine whether the combination of stop positions (i.e., translating to a combination of displayed symbols) results in a winning symbol combination.

Returning to FIG. 2, control unit 200 controls the function and output of a plurality of output devices utilized by gaming device 100. In various embodiments, I/O controller 206 serves as an interface unit between specially configured processor 202 and output devices such as video processor 216, cabinet lighting controller 218, audio controller 220, and value dispenser 222.

In one embodiment, video processor 216 communicates with specially configured processor 202 to render all game graphics, video displays, and information on gaming device 100's one or more video display units. In one embodiment, video processor 216 includes one or more processors, controllers, and/or graphics cards for processing the game images, outcomes, and animated displays and coordinating the processed data to be display between, among, or across any or all display devices. In various embodiments, this may include being configured to simulate objects and the movement of objects which represent video reels containing sets of gaming symbols.

It should be appreciated that in certain other embodiments where physical mechanical reels are utilized by the gaming device 100 as a game displays, reel controllers and stepper motors would be provided in lieu of or in addition to video processor 216.

In embodiments which utilize cabinet lighting as described with respect to FIG. 1, a cabinet lighting controller 218 may be utilized to coordinate and control the color and timing of cabinet lighting displays with specially configured processor 202. In certain embodiments which utilize sound design, specially configured processor 202 may utilize audio controller 220 to coordinate and control the sound emissions. In one embodiment, audio controller 220 may include one or more audio processing cards for generating sound and for driving the one, two or more speakers that may be included with gaming device 100.

In various embodiments, players may collect remaining credit value by initiating a signal via player control 212 which is communicated to specially configured processor 202 via I/O controller 206. The signal triggers a readout of the player's credit amount and specially configured processor 202 initiates a value dispensing signal which, in turn, is communicated to value dispenser 222. In one embodiment, value dispenser 222 can be controlled to issue the player's credit value using any of the types of value discussed herein. In some embodiments, the player's credit value may be issued to the player via a printed and dispensed encoded paper ticket or token which the player can then exchange at a special purpose kiosk or cashier location for the monetary value encoded into the ticket or token. In some embodiments, the specially configured processor 202 can direct the value dispenser 222 to issue to the player an appropriate amount of coin or bills directly to the player. Additionally, or alternatively, in some embodiments, the player may have the option to electronically direct the credit value to an account associated with the player.

In some embodiments, control unit 200 of gaming device 100 may communicate with one or more devices outside the gaming device 100. For example, gaming device 100 may be connected to a larger gaming network via a local area network (LAN) or a wide area network (WAN). Control unit 200 may communicate with one or more central servers, controllers, or remote devices to execute games, establish credit balances, participate in jackpots, etc. In such embodiments, network communications and connections are accomplished via a network interface controller 224. Network interface controller 224 can be a digital circuit board or card installed in control unit 200 to provide network communications with external devices.

In some embodiments, various additional features and functions are performed by control unit 200. For example, control unit 200 may be specially configured with appropriate software to track all game play events that occur on gaming device 100. In some embodiments, control unit 200 may audit all recorded monetary transactions, including all wager amounts, game outcomes, game winnings, and game payouts that occur through gaming device 100. Further, some embodiments may include security software to assist in protecting the gaming device 100 from tamper or alteration attempts.

### Gaming System Operation

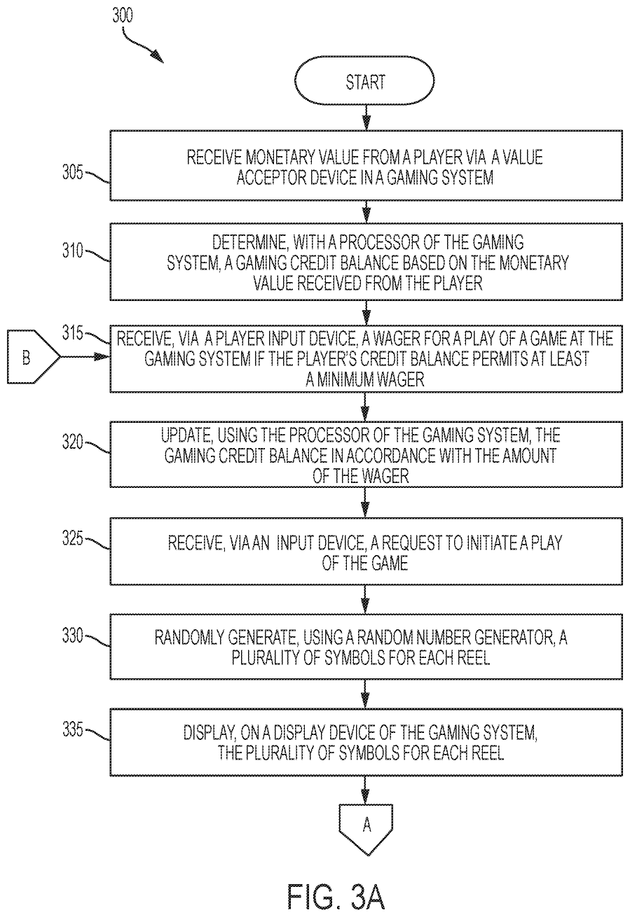

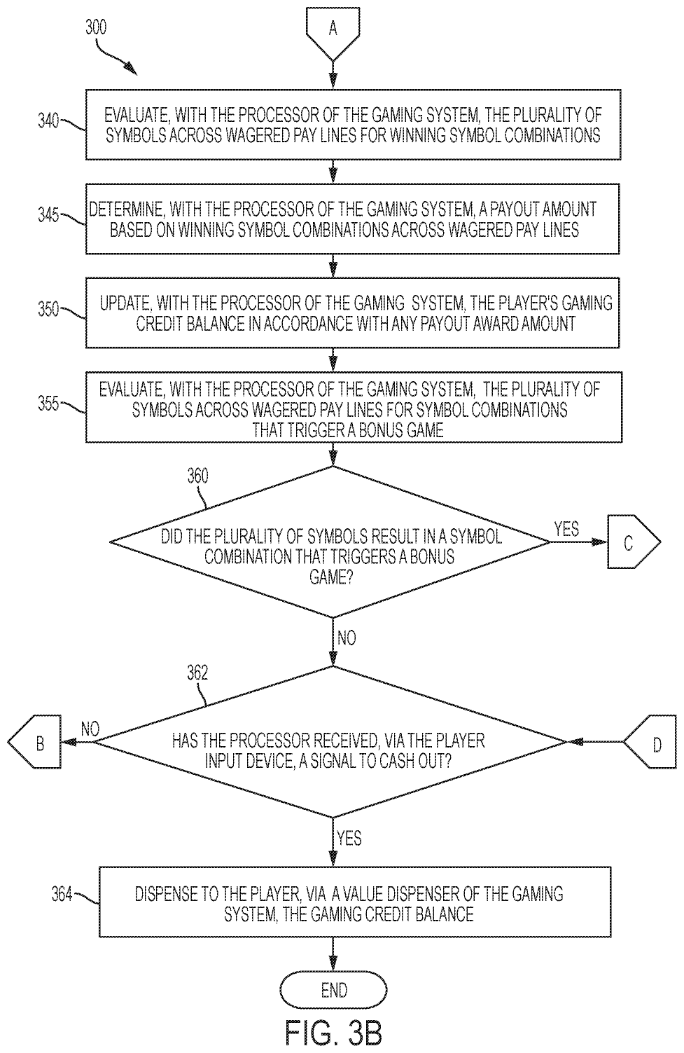

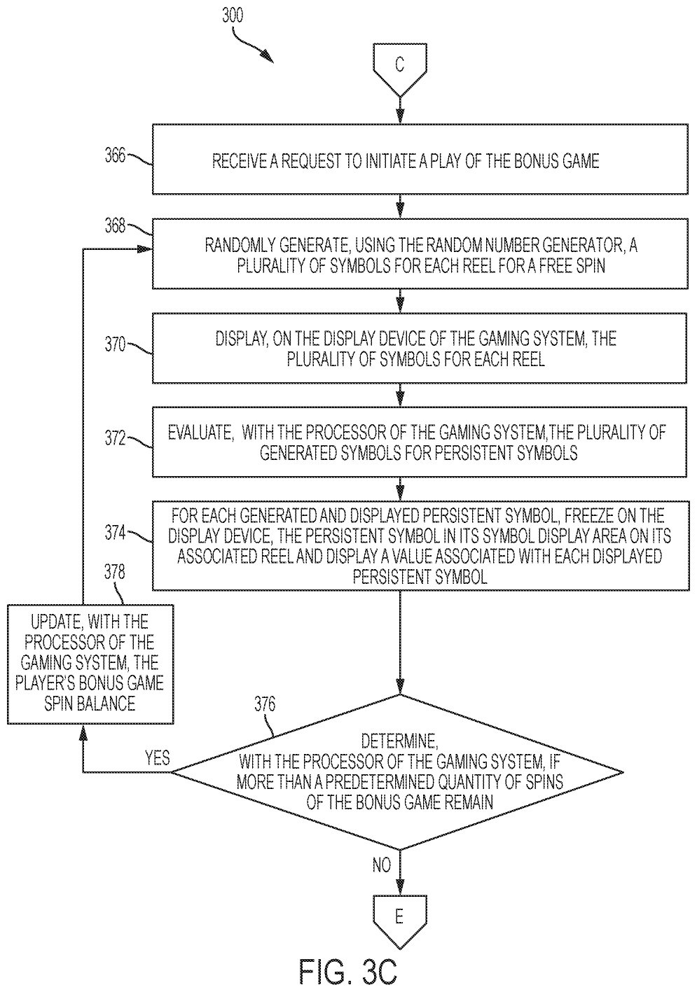

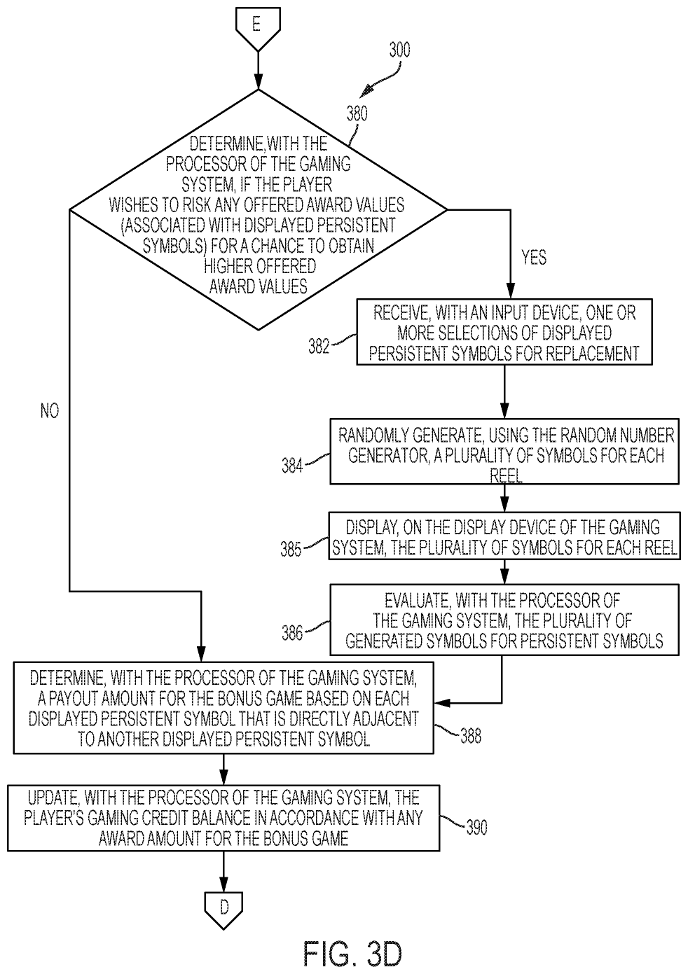

FIGS. 3A, 3B, 3C, and 3D illustrate a flowchart of an example operation 300 of one embodiment of the gaming system and method. FIGS. 3A and 3B are depicted as a base or primary game while FIGS. 3C and 3D are depicted as a bonus game. However, it should be appreciated that FIGS. 3C and 3D may be integrated as part of a base game without entering a separate bonus game.

In one embodiment, a processor of the gaming system is configured, via instructions stored in a memory device, to perform the operation 300. However, it should be appreciated that other suitable variations of operation 300 are possible. For example, in one embodiment, fewer or one or more additional blocks (not shown) may be employed in operation 300 of the gaming system and method. In other embodiments, the blocks may be performed in any suitable order.

FIG. 3A illustrates one embodiment in which the gaming system receives a monetary value from a player to initiate operation 300. As indicated in block 305, the gaming system may receive monetary value via a value acceptor device associated with the gaming system. The value acceptor device, in one embodiment, is disposed in a gaming system or in communication with the gaming system as discussed above.

In one embodiment, the gaming system determines a credit balance based on the monetary value received from the player at a value acceptor device as indicated in block 310. The gaming system determines, via a processor, a gaming credit balance for the player. The gaming credit balance may be based on the monetary value received from the player at the value acceptor device.

In one embodiment, the gaming system may receive a wager for a play of a game at the gaming system. Block 315 of FIG. 3A illustrates one embodiment where the player's wager is received via a player input device. The gaming system may allow a player to place a minimum wager, a maximum wager, or any suitable wager amount. Depending on the wager amount, the gaming system may also enable the player to select pay lines across displayed symbol positions (e.g., symbol display areas) on reels in a game in which to place wagers. Although in some embodiments, the gaming system selects the wagered pay lines automatically based on the player's wager. Wagered pay lines may be referred to herein as active pay lines. In one embodiment, the gaming system may determine whether the player provided enough credits to enable the player's selected wager. The gaming system may prevent the player from placing the wager and starting a play of a game if the player's credit balance is not large enough to support the player's selected wager. If enough credits are not available in the player's credit balance, the gaming system enables the player to insert additional value to obtain the minimum credit level or to cash out of the gaming system.

In one embodiment, the gaming system may use a processor of the gaming system to update a gaming credit balance. The credit balance may be updated in accordance with the player's wager amount as indicated in block 320. In some embodiments, the credit balance is not updated until a later time.

Block 325 illustrates one embodiment in which the gaming system may receive a request to initiate a play of a game. The request to initiate the play of the game may be received from a player via a player input device in communication with the gaming system. The gaming system may securely access game data from a memory device and execute an authentication routine on the game data to start a play of a game as discussed above. For example, the player may press a spin button on the gaming system to start spinning slot machine reels of the gaming system (or randomly generating symbols using other methods discussed above for virtual reels) for the play of the game. It should be appreciated that reels used throughout the specification may refer to mechanical reels, electro-mechanical reels, or virtual video reels (where virtual reels strips or no reel strips are used). It should further be appreciated that although many examples illustrated in the specification describe the games in terms of slot machines with reels, other games may be used, including games without slot machine reels.

In one embodiment, the gaming system may use a random number generator to randomly generate a plurality of symbols from a plurality of sets of symbols as indicated in block 330. In some embodiments, the gaming system may generate the plurality of symbols for display on a set of reels (or virtual reels). In some such embodiments, each reel is associated with its own set of symbols. As used herein, the random number generation may refer to pseudo-random or true-random number generation depending on the module used for the random number generation.

In one embodiment, the gaming system may cause a display device to display the plurality of symbols generated as indicated in block 335. In a game using reels, the gaming system may display the generated plurality of symbols in visible symbol display areas of each of the reels. Off page connector A refers to FIG. 3B to continue operation 300.

Turning now to FIG. 3B and off page connector A, in one embodiment as shown in block 340, the gaming system evaluates the generated plurality of symbols across active or wagered pay lines for winning symbol combinations. In some embodiments, the gaming system evaluates the winning symbol combinations based on the pay lines wagered upon by a player. The gaming system may evaluate the player selected pay lines, gaming system assigned pay lines, or pay lines assigned as active in some other manner for the play of the game. In one embodiment using reels, the gaming system determines an award amount based on winning symbol combinations formed across the reels on active pay lines. For example, if a pay table associated with the gaming system indicated that at least three of the same bar symbols is a winning symbol combination and awards a predetermined payout, the gaming system would evaluate the generated plurality of symbols for bar symbols. If the gaming system generated at least three bar symbols on adjacent reels and along an active pay line, the gaming system may determine that the three bar symbols is a winning symbol combination based on the predetermined pay table. It should be appreciated that a pay table may include any suitable number of winning symbol combinations and payouts. In one embodiment, a pay table may indicate that as few as one symbol may be associated with a payout. Alternatively, two or more symbols may be used to form winning symbol combinations that result in a payout.

In block 345, the gaming system determines, with the processor, a payout amount based on the evaluated winning symbol combinations across wagered pay lines. As illustrated in block 350, the gaming system may update, with the processor, the player's gaming credit balance in accordance with any award amount. As noted above, the blocks illustrated in FIGS. 3A-3D can be rearranged in any suitable order. As such, it should be appreciated that the gaming system may update player's gaming credit balance at other suitable times.

In one embodiment, as indicated in block 355, the gaming system evaluates the plurality of symbols across wagered pay lines for symbol combinations that trigger a bonus game with a predetermined quantity of spins (or activations, where the bonus game does not use slot reels). In some embodiments the symbol or symbol combinations that trigger the bonus game do not need to appear on wagered pay lines. In some embodiments, the predetermined quantity of spins are provided as free spins. In other embodiments, the player may pay to obtain the predetermined quantity of spins. It should also be appreciated that in some embodiments, events other than generating one or more of a predetermined symbol may trigger the bonus game. If the gaming system determined that the generated plurality of symbols did not result in triggering a bonus game, in block 360, operation 300 moves to block 362. In one embodiment, as indicated in block 362, the gaming system may receive a signal to end game play or “cash out” via an input device of the gaming system. In such a situation, the gaming system dispenses a value to the player, through a value dispenser, based on the player's gaming credit balance as illustrated in block 364 and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

Returning now to block 360, if the gaming system determined that the generated plurality of symbols resulted in trigging a bonus game, operation 300 moves to block 366 in FIG. 3C via off page connector C. In one embodiment, if the gaming system determines that the generated plurality of symbols includes one or more generated predetermined symbols, the gaming system will trigger or activate the bonus game. In one embodiment, the predetermined symbol is a symbol that serves one function: to trigger the bonus game. In alternative embodiments, the predetermined symbol serves a plurality of game functions, such as triggering the bonus game and providing an award value. Other suitable game functions may be associated with the predetermined symbol.

In some embodiments, the gaming system alters the play of the game during the bonus game. In some embodiments, the gaming system may change how symbols operate. In some embodiments, the gaming system may use different pay tables in the bonus game to calculate winning symbol combinations. In some embodiments where a symbol operation is altered, the gaming system designates at least one symbol in each of the symbol sets as a persistent symbol (as also referred to herein as a freeze symbol or frozen symbol) during the bonus game. In some embodiments, the persistent symbol is the same symbol as the predetermined symbol to trigger a bonus game. In other embodiments, the persistent symbol is different from the predetermined symbol to trigger a bonus game. In one embodiment, if the gaming system generates and displays a persistent symbol in a particular symbol display area on a reel in any spin of the bonus game, the gaming system keeps the persistent symbol in that particular displayed symbol area for the duration of the remaining spins of the bonus game. Thus, in one such embodiment, a persistent symbol generated and displayed in a symbol display area during a first spin of the bonus game may remain displayed in that same symbol display area for the duration of the remaining spins of the bonus game. It should be appreciated that in some embodiments, the persistent symbol with the same or similar characteristics may be used in the base game too.

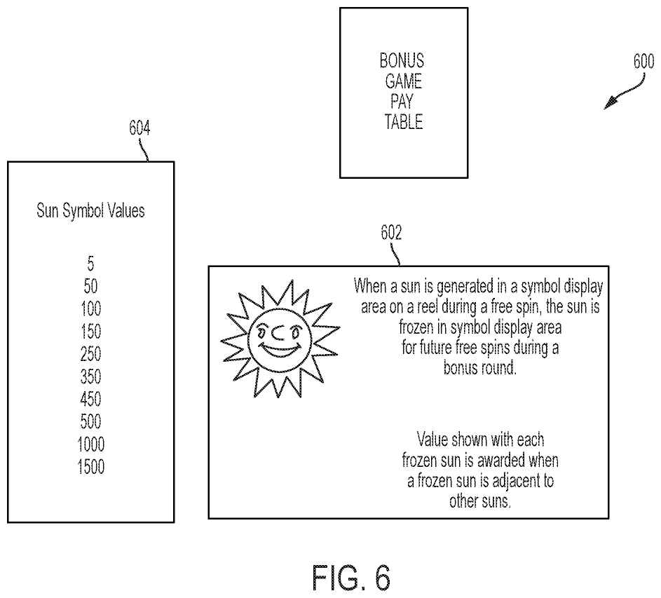

In one embodiment, the gaming system changes the pay table for the bonus game. In one embodiment, the altered pay table removes the need for a predetermined quantity of persistent symbols to be generated along a pay line to result in a winning symbol combination (See, e.g., FIG. 6). In one embodiment, the persistent symbol can be associated with a plurality of different award values without regard to a wagered pay line. In some embodiments, the gaming system randomly assigns one of the plurality of different award values to a persistent symbol before, during, or after a persistent symbol is generated and displayed in a particular symbol display area. In some embodiments, the persistent symbol award values are awarded if two or more persistent symbols are generated and displayed directly adjacent to each other in the symbol display positions on the reels. That is, to obtain the persistent symbol award values as an offered award, a first persistent symbol must touch at least one other persistent symbol in a symbol display area that is directly above, directly to the left, directly to the right, or directly below the first persistent symbol to create a persistent symbol group. In some embodiments, the gaming system does not award an award value associated with a persistent symbol when the persistent symbol is not touching at least one other persistent symbol in a symbol display area that is directly above, directly to the left, directly to the right, or directly below the first persistent symbol. In some embodiments, a predetermined quantity of persistent symbols must be in a persistent symbol group before the gaming system awards the values associated with the persistent symbols in the persistent symbol group. In some such embodiments, the pay table for the bonus game reduces or eliminates other symbol combinations that results in awards values. Thus, in some embodiments, the gaming system offers award values associated with persistent symbols in persistent symbol groups, but not for other symbol combinations. In some embodiments, the persistent symbols do not need to be displayed in a persistent symbol group for the player to obtain award values associated with the displayed persistent symbols (e.g., if a persistent symbol is displayed, then the gaming system offers an associated award value to the player).

Block 366 of FIG. 3C illustrates one embodiment in which the gaming system may receive a request to initiate a play of the bonus game. It should be appreciated that each play of the bonus game corresponds to one of the awarded predetermined quantity of spins for the bonus game. It should also be appreciated that each play of the bonus game may occur within a play of the game (e.g., the play of the game is a combination of the base game and the bonus game). As noted above, the features discussed in connection FIG. 3C may also be applied to primary games or games that are not bonus games. The request to initiate the play of the bonus game may be received from a player via a player input device in communication with the gaming system. For example, the player may press a spin button on the gaming system to start randomly generating symbols for the play of the bonus game. In an alternative embodiment, the processor of the gaming system may automatically initiate the play of the bonus game and randomly generate symbols for the play of the game.

In one embodiment, the gaming system uses a random number generator to randomly generate a plurality of symbols from one or more bonus symbol sets for the bonus game as indicated in block 368, for a spin of the bonus game. In some embodiments, the bonus symbol sets comprise one or more symbols that are different from the symbols from the primary game's symbol sets. In some embodiments, the bonus symbol sets comprise the same symbols from the primary game's symbol sets. For some embodiments without a bonus game, the gaming system randomly generates the plurality of symbols from one or more second symbol sets. In some embodiments without a bonus game, the gaming system randomly generates the plurality of symbols from the same set, but may activate features associated with particular symbols, such as features associated with the persistent symbols.

In one embodiment, the gaming system may cause a display device to display the plurality of symbols generated as indicated in block 370. In a game using reels, the gaming system may display the generated plurality of symbols in visible symbol display areas of each of the reels.

The gaming system evaluates, with the processor of the gaming system, the generated plurality of symbols for persistent symbols (or freeze symbols) as indicated in block 372. For each generated persistent symbol, the gaming system will hold or maintain the persistent symbol on the display as indicated in block 374. In some embodiments, the gaming system continues to display the persistent symbol in its generated symbol display area for the remainder of the bonus game (e.g., until no spins of the bonus game remain). In some embodiments, when a persistent symbol is generated and displayed, an award value is associated with and displayed with the persistent symbol. In some embodiments, when a plurality of award values are displayed with the generated and displayed persistent symbols, a sum of the displayed award values are an offered bonus award to the player. In some embodiments, the displayed award values can be considered portions of the offered bonus award.

In some embodiments, when a persistent symbol is generated and displayed, no value is displayed in association with the persistent symbol unless the persistent symbol is generated and displayed directly adjacent to another generated and displayed persistent symbol. The value for the persistent symbol may be generated and assigned to the generated and displayed persistent symbols at different times during the play of the game, as previously discussed.

In block 376, the gaming system determines, with the processor of the gaming system, if more than a predetermined quantity of spins of the bonus game remain. The gaming system may check a bonus game spin counter or spin balance in its memory for remaining spins. If additional spins remain, the gaming system updates, with a processor, the player's bonus game spin balance as indicated in block 378. Process 300 returns to block 368, where the gaming system, using the random number generator, randomly generates a second plurality of symbols from one or more bonus symbol sets for the bonus game as indicated in block 368, for another spin of the bonus game. The process 300 continues to loop through blocks 368-378 until the condition in block 376 is not true (e.g., if more than the predetermined quantity of spins of the bonus game do not remain). In one embodiment, the predetermined quantity of spins is one. In one such embodiment, if the gaming system determines that only one spin remains at block 376, the gaming system will not return to block 378. It should be appreciated that the predetermined quantity of spins can be any suitable number.

In some embodiments where the bonus game is a reel game, when a persistent symbol is generated and persistently displayed in a symbol display area during a previous spin of the bonus game, such previously generated persistent symbol does not interfere with symbols being displayed spinning on the reels. In one embodiment, for subsequent spins during the bonus game, when the reels are spinning, the symbols on the reels are displayed behind any previously generated and displayed persistent symbols. When the reels stop (when the gaming system generates symbols for the reels for the spin), the gaming system may evaluate all of the generated symbols for persistent symbols. In some embodiments, the gaming system saves memory and processing power by limiting the evaluation of the currently generated symbols for persistent symbols to symbol display areas that did not have a displayed persistent symbol during the bonus game. As additional spins are processed, the gaming system may continue to reduce the quantity of symbol display areas requiring evaluation as persistent symbols are generated during different and subsequent spins of a bonus game. In some embodiments, if a persistent symbol is generated and displayed in a symbol display area, the gaming system does not replace the persistent symbol with a new persistent symbol in subsequent spins of the bonus game.

If more than the predetermined quantity of spins of the bonus game do not remain per the bonus game spin balance, the process of operation 300 continues to block 380 via off page connector E in FIG. 3D. In one embodiment, gaming system may have generated and displayed a plurality of persistent symbols for the bonus game. The displayed plurality of persistent symbols may each have an associated award value that is offered to the player. A sum of such award values is the player's offered bonus award. Thus, the offered award values are portions of the offered bonus award. In one embodiment, the player may obtain the offered bonus award and cash out of the game without playing the last spin of the bonus game. In other embodiments, the gaming system may not randomly generate any additional persistent symbols for the remaining spin, leaving the player with the same offered bonus award. In some embodiments, some of the offered award values could be the lowest award values available in the bonus game. In some embodiments, the offered award values may be lower than the highest available award values. If the displayed persistent symbols are not associated with the highest available award values, the player has not obtained highest offered bonus award. An inability to obtain the highest offer bonus award can be disappointing to players.

To add additional excitement to the game, to permit the player to improve the offered bonus award, and to mitigate the player's disappointment with the gaming system, the gaming system is configured to enable the player to select a predetermined quantity of displayed persistent symbols for removal in some embodiments. When displayed persistent symbols are removed, the player forfeits the offered award values associated with the removed persistent symbols. In such an embodiment, once the displayed persistent symbols are removed, the gaming system can potentially randomly generate persistent symbols associated with higher award values in place of the removed persistent symbols in the next spin of the bonus game. In other words, the gaming system enables the player to risk at least a portion of the offered bonus award and attempt to improve the offer bonus award in a subsequent spin of the bonus game.

In one embodiment, the gaming system offers the player a predetermined quantity of removal selections. In some embodiments, the predetermined quantity removal selections is one. In some embodiments, the predetermined quantity of removal selections is at least two. It should be appreciated that the predetermined quantity of removal selections can be any suitable number of removal selections in some embodiments. In some embodiments, the gaming system enables the player to select all displayed persistent symbols for removal (e.g., allowing the player to risk all offered award values). In some embodiments, gaming system offers a predetermined quantity of removal selections for free. In some embodiments, gaming system charges (or requires a predetermined wager or a dynamically determined wager) for at least one removal selection. In one embodiment, the dynamically determined wager is based on fractional credit amounts remaining in a player's credit balance. Such an embodiment using fractional credit amounts is discussed in more detail below. In some embodiments, gaming system charges (or requires a predetermined wager or a dynamically determined wager) for a plurality of removal selections. In some embodiments, gaming system charges for each removal selection. In some embodiments, the charges are nominal fees. It should be appreciated that the charges can be set at any suitable value.

In some embodiments, the gaming system may charge the player (or determined the wager) based on the player's fractional credit balance. For example, a player's credit balance may have been reduced to a value that is below a minimum wager amount required for a play of the game on the gaming system (e.g., $0.23). The player may not be able to place a wager on the gaming system for a play of the game with such a low value. The value is also so low that the player may not bother with the hassle of obtaining the $0.23 credit. In some such embodiments, the gaming system may offer one or more removal selections in exchange for at least a portion or all of the player's fractional credit balance. In some embodiments, the player's fractional credit balance can be used to purchase an additional spin of the bonus game. This fractional wager enables the gaming system to collect additional fees, allows the player to play the game longer and obtain an additional chance to improve the player's offered bonus award, and saves the fractional credit balance from being lost to both the casino and the player.

Returning to block 380, the gaming system determines with the processor, if the player wishes to risk any offered award values (associated with displayed persistent symbols) for a chance to obtain higher offered award values (e.g., improve the offered bonus award).

If the player is risk adverse or the player is satisfied with the offered bonus award, the gaming system may receive an indication from the player (such as a button selection) that the player does not wish to risk any offered award values. In such a case, process 300 moves to block 388. In block 388, the gaming system determines, with the processor, a payout amount for the bonus game based on each displayed persistent symbol. As noted above, in some embodiments, the payout amount is based on each displayed persistent symbol being displayed is directly adjacent to another displayed persistent symbol. In block 390, the gaming system, using the processor, updates the player's gaming credit balance in accordance with any award amount for the bonus game and may proceed to off page connector D and return to block 362 in FIG. 3B.

On the other hand, the gaming system may receive an indication from the player (such as a button selection) that the player wishes to risk at least one offered award value (at least a portion of an offered bonus award) at block 380. In one embodiment, the gaming system enables the player to make one or more selections of displayed persistent symbols for replacement. As illustrated in block 382, the gaming system receives, with an input device, one or more player selections of displayed persistent symbols for replacement. For example, the player may select displayed persistent symbols for removal via a touchscreen of the gaming system. In one embodiment, the player may select one lowest award value for replacement. In alternative embodiments, the player may select all of the lowest award values for replacement. In still other embodiments, the player may select any one or more displayed award values for replacement.

In some embodiments, the gaming system can be configured to make the selections automatically for the player. For example, the gaming system can be configured to make the optimal selections for the player (e.g., all of the lowest award values for replacement). The gaming system can be configured, in some embodiments, to make selections based on player's risk profile. For example, in one embodiment, the gaming system may ask the player if the player desires to make low risk selections, medium risk selections, or high risk selections. For low risk selections, the gaming system may automatically select a predetermined percentage of the lowest offered award values. For medium risk selections, the gaming system may automatically select all of the lowest offered award values and a certain percentage of offered award values that are less than the highest award values. For high risk selections, the gaming system may automatically select all of the offered award values for removal.

Once selections of the displayed persistent symbols have been made, the gaming system may remove the selected persistent symbols from the display. Removing the selected persistent symbols enables the gaming system to potentially randomly generate and display new persistent symbols in symbol display areas that were previously occupied by persistent symbols during the bonus game.

In one embodiment, the gaming system uses a random number generator to randomly generate a plurality of symbols from one or more bonus symbol sets for a final spin of the bonus game, as indicated in block 384. In one embodiment, the gaming system may cause the display device to display the plurality of symbols generated as indicated in block 385. However, as with prior spins of the bonus game, for symbol display areas with existing displayed persistent symbols, the gaming system does not replace the existing displayed persistent symbols with newly generated persistent symbols for such symbol display areas. On the other hand, for symbol display areas where previously displayed persistent symbols were selected and removed, the gaming system may display any newly generated persistent symbols in these symbol display areas.

In some embodiments, the gaming system may not randomly generate new persistent symbols for symbol display areas where previously displayed persistent symbols were selected and removed. In some embodiments, the gaming system may randomly generate new persistent symbols for symbol display areas where previously displayed persistent symbols were selected and removed that are associated with award values that are equal to or lower in value than the removed award values. On the other hand, in some embodiments, the gaming system may randomly generate new persistent symbols for symbol display areas where previously displayed persistent symbols were selected and removed that are associated with award values that are greater in value than the removed award values. In other words, by selecting and removing persistent symbols, the player is risking offered award values for the potential of higher offered award values. However, the player may also lose any offered award values that are removed.

The gaming system evaluates, with the processor of the gaming system, the generated plurality of symbols for persistent symbols as indicated in block 386. As illustrated in FIG. 3D, after the final spin of the bonus game, process 300 moves to block 388.

In block 388, the gaming system determines, with the processor, a payout amount (the offer bonus award) for the bonus game based on a sum of the award values associated with each displayed persistent symbol. In some embodiments, the payout amount is restricted to a sum of the award values associated with displayed persistent symbols. In some embodiments, the payout amount is restricted to a sum of the award values associated with displayed persistent symbols that are directly adjacent to another displayed persistent symbol. In block 390, the gaming system, using the processor, updates the player's gaming credit balance in accordance with any offered bonus award amount for the bonus game and may proceed to off page connector D and return to block 362 in FIG. 3B.

As indicated in block 362, the gaming system may receive a signal to end game play or “cash out” via an input device of the gaming system. In such a situation, as illustrated in block 364, the gaming system dispenses a value to the player through a value dispenser based on the player's gaming credit balance and operation 300 ends.

On the other hand, if the gaming system processor has not received a signal to end game play via the player input device, the process of operation 300 returns to block 315 via off page connector B. The gaming system may receive, via a player input device, a wager for another play of the game and continue operation 300 from block 315. However, in one embodiment, the wager may not be accepted if the player has fewer credits than the player's selected wager amount as shown in block 315.

In one embodiment of process 300, the gaming system enables a player to select and remove persistent symbols after one or more spins of the bonus game. In some embodiments, the gaming system enables a player to select and remove persistent symbols after every spin of the bonus game.

In some embodiments, the gaming system enables a player to select and remove persistent symbols after every spin of the bonus game, except for after the last spin of the bonus game. In some such embodiments, the gaming system provides the player such selections and removals without any fees (e.g., no additional wagers). In one embodiment, after the last spin of the bonus game, the gaming system enables the player to purchase additional removal selections and at least one additional spin of the bonus game for a chance to improve the player's offered bonus award.

In some embodiments, the player is permitted to select and replace persistent symbols after a predetermined number of spins, such as two spins of the bonus game.

In some embodiments, the player may purchase the ability to select and remove displayed persistent symbols before the play of the game. In some embodiments, the player may purchase the ability to select and remove displayed persistent symbols during the play of the game, but before the bonus game. In some embodiments, the player can purchase the ability to select and remove displayed persistent symbols at any suitable time before, during, or after the play of the game. In some embodiments, the purchase (or wager) may be different (higher or lower) depending on when the player purchased the ability to select and remove displayed persistent symbols.

In some embodiments, the gaming system enables the player to make selections for removal of persistent symbols once (or some predetermined quantity of times) during the bonus game (e.g., after one of a plurality spins of the bonus game), but the player must determine the best time to make the selections of persistent symbols for removal.

In one embodiment, after a last spin of the bonus game, the gaming system enables the player to purchase at least one additional spin of the bonus game for a chance to improve the player's offered bonus award. In some situations, this embodiment may help a player that has, for example, obtained persistent symbols in all available symbol display areas except for one available symbol display area. The gaming system may enable the player to place an additional wager or otherwise purchase the opportunity for at least one additional spin in an attempt to obtain one additional persistent symbol in the one remaining available symbol display area.

In some embodiments, the gaming system only enables the player to obtain replacement persistent symbols after no spins remain in the bonus game. In some embodiments with reels, the gaming system spins the reels having selected and removed persistent symbols. Thus, reels without removed persistent symbols are not re-spun (symbols are not generated for such reels). By not generating symbols for reels that do not need symbols, the gaming system more efficiently uses its processor, memory, and lowers power consumption by not performing unneeded computations to generate unnecessary symbols. In some embodiments, a reel that generates and displays one symbol from a plurality of symbols are associated with symbol display areas where a persistent symbol was selected and removed. The symbols for such a reel may be the same or similar to the symbols in the bonus symbol set. In some embodiments, the reel that generates and displays one symbols is used in place of bonus reels to generate new symbols for symbol display areas where a persistent symbol was selected and removed.

In some embodiments, the player can select a row of persistent symbols for replacement. In some embodiments, the player can select a column of persistent symbols (or a reel) for replacement. In some embodiments the player cannot select individual persistent symbols, but can only select a row for replacement, a column for replacement, or a combination of both for replacement.

In some embodiments, the gaming system enables the player to purchase or place a wager to replace a value amount. For example, the gaming system enables the player to place a wager for a chance to replace up to 200 credits in offered award values in one embodiment. The gaming system may enable the player to select different combinations of offered award values to obtain the 200 credits. For example, the player can select one 200 credit offered award value; two 100 credit offered award values; four 50 credit offered award values; a 150 credit offered award value and a 50 credit offered award value; or some other suitable offered award value combination. In some such embodiments, the player must carefully strategize to determine which of the available offered award values the player should select for replacement and a chance to improve the player's offered bonus award.

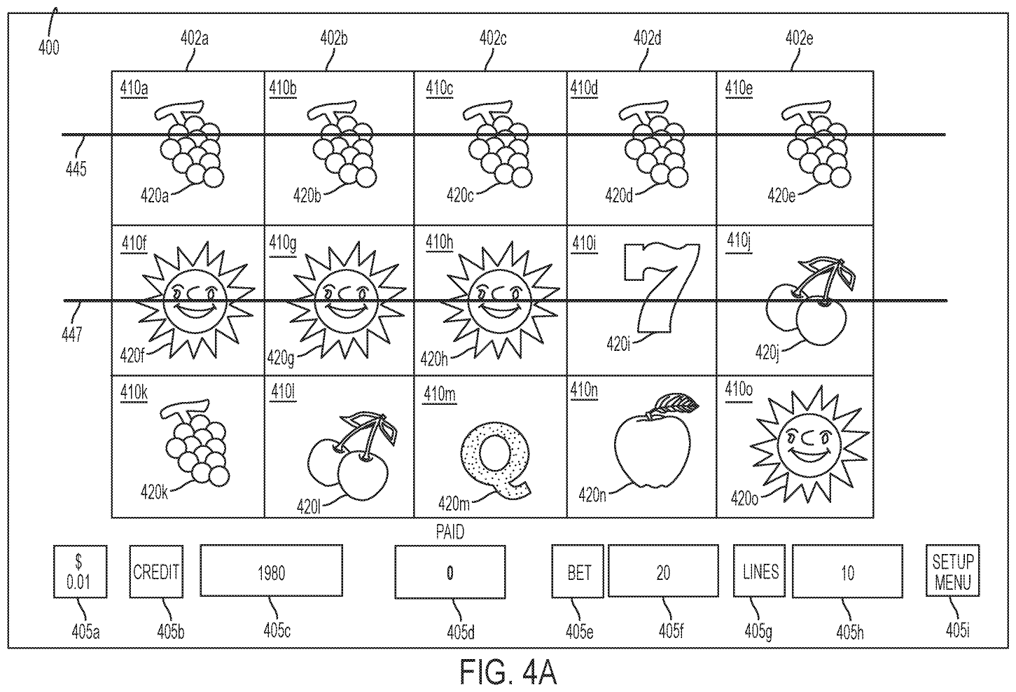

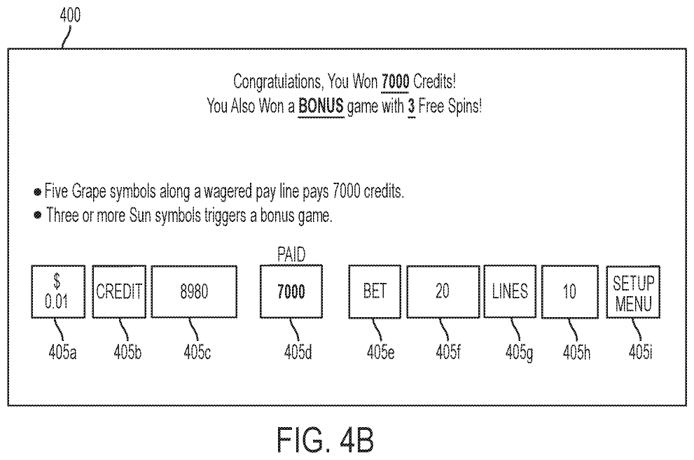

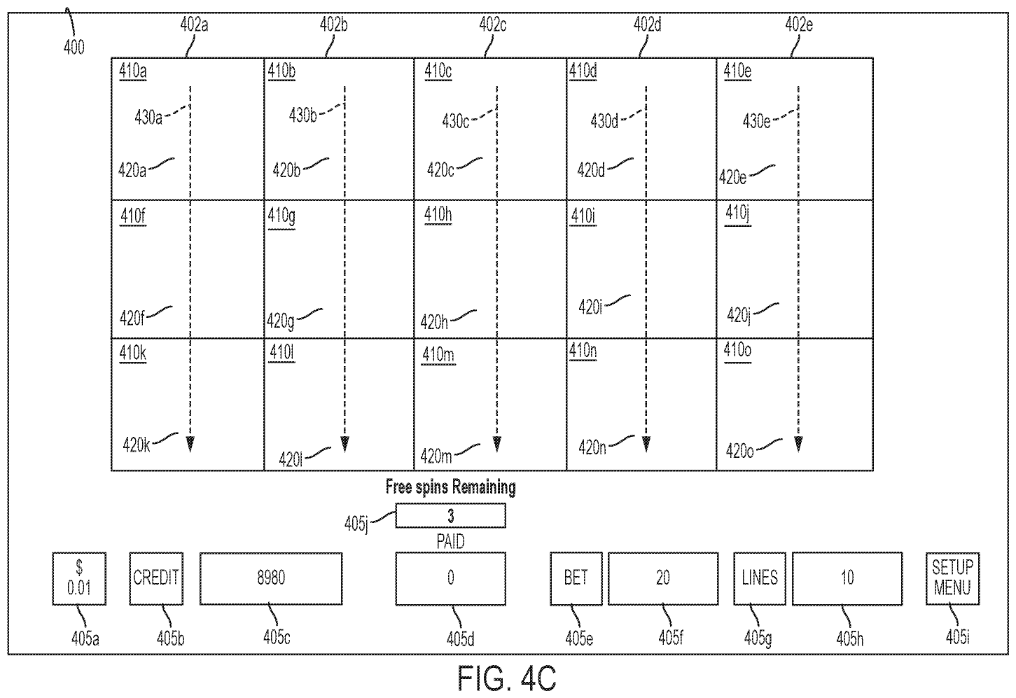

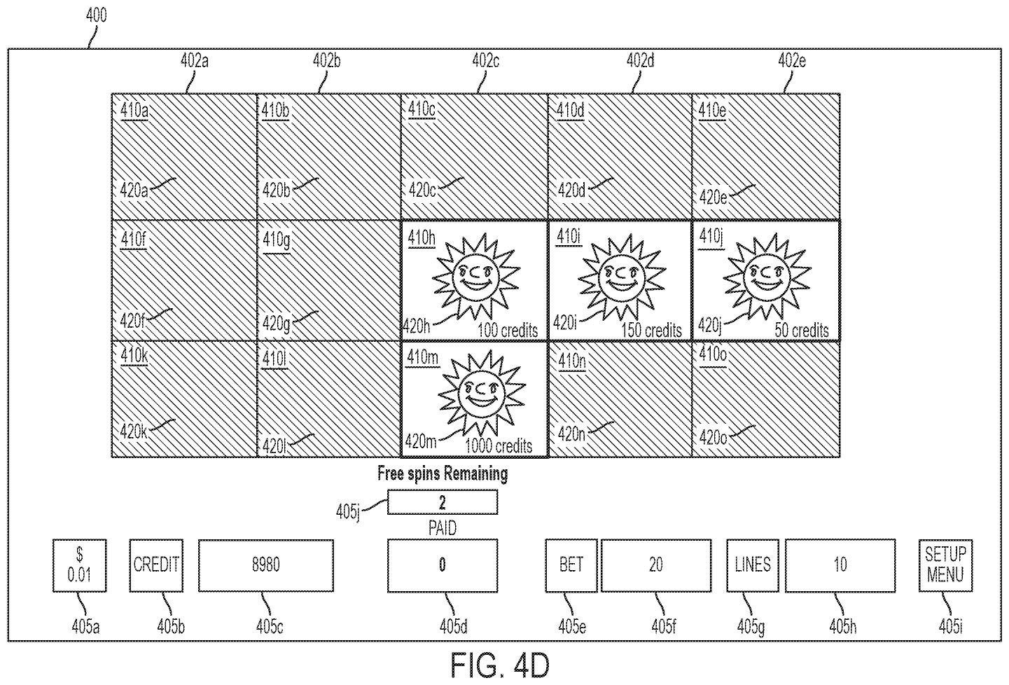

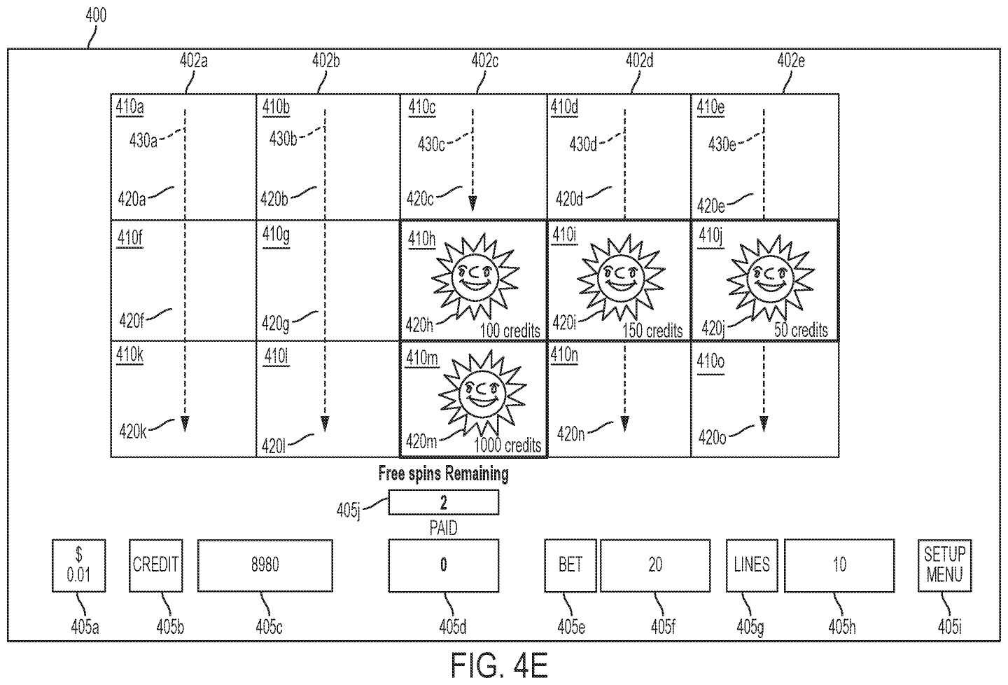

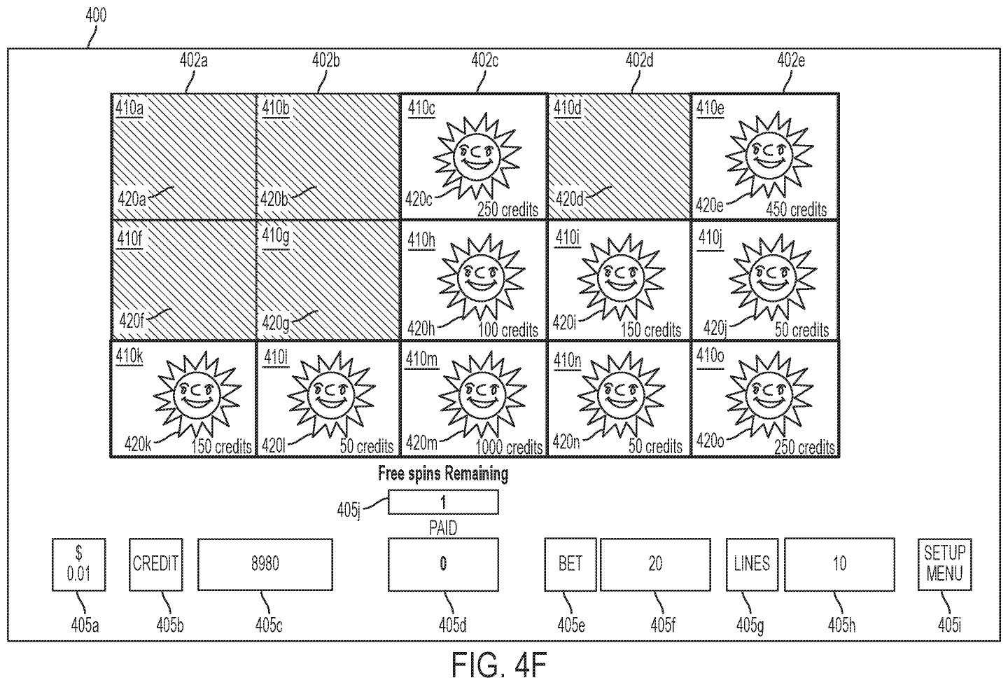

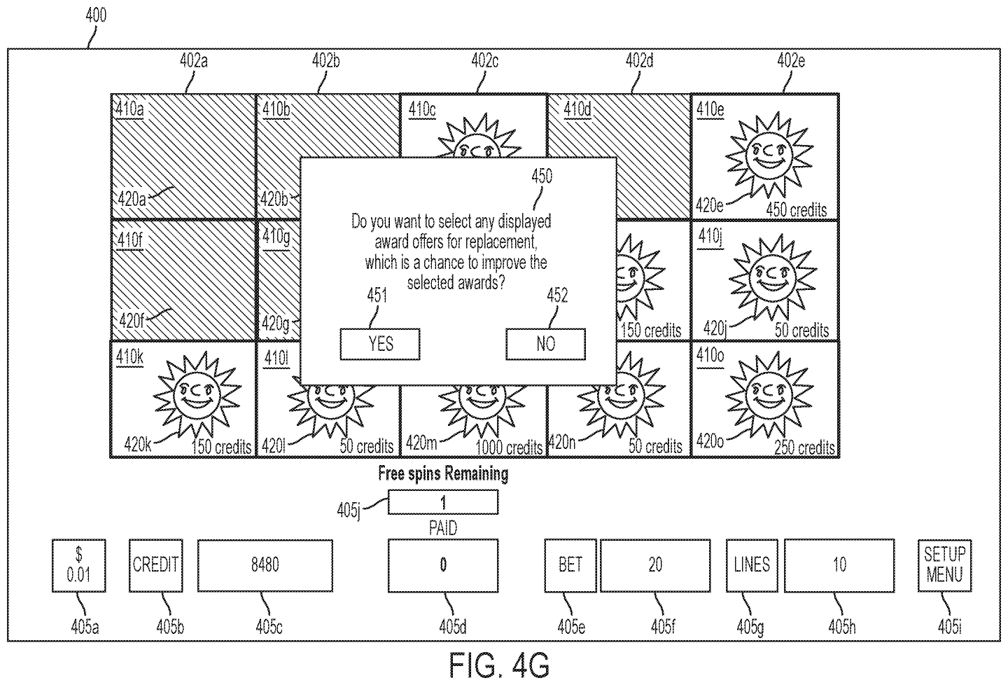

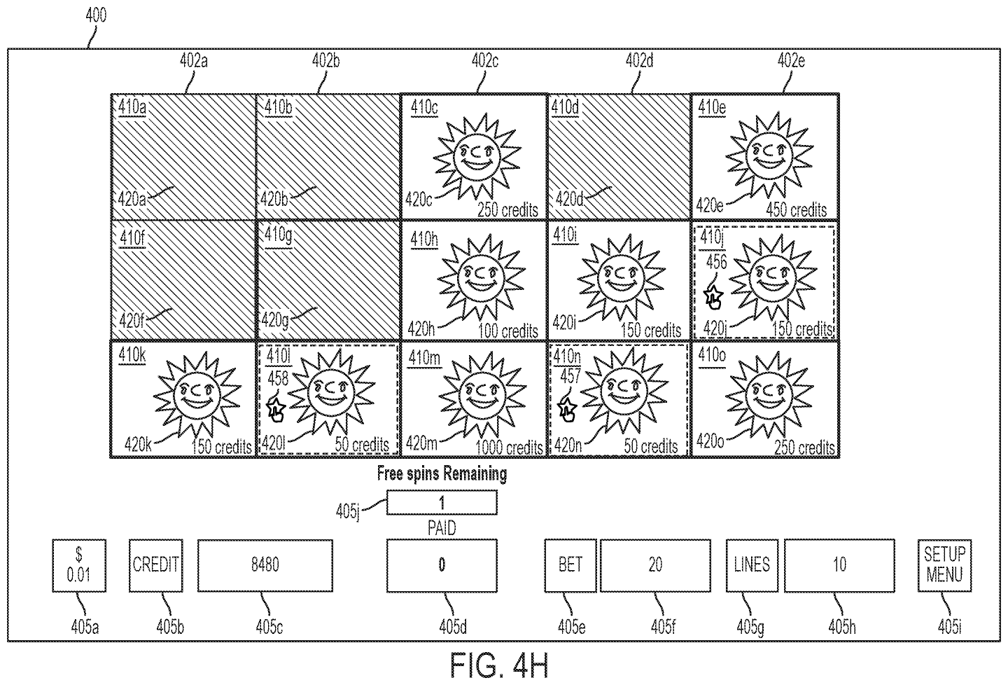

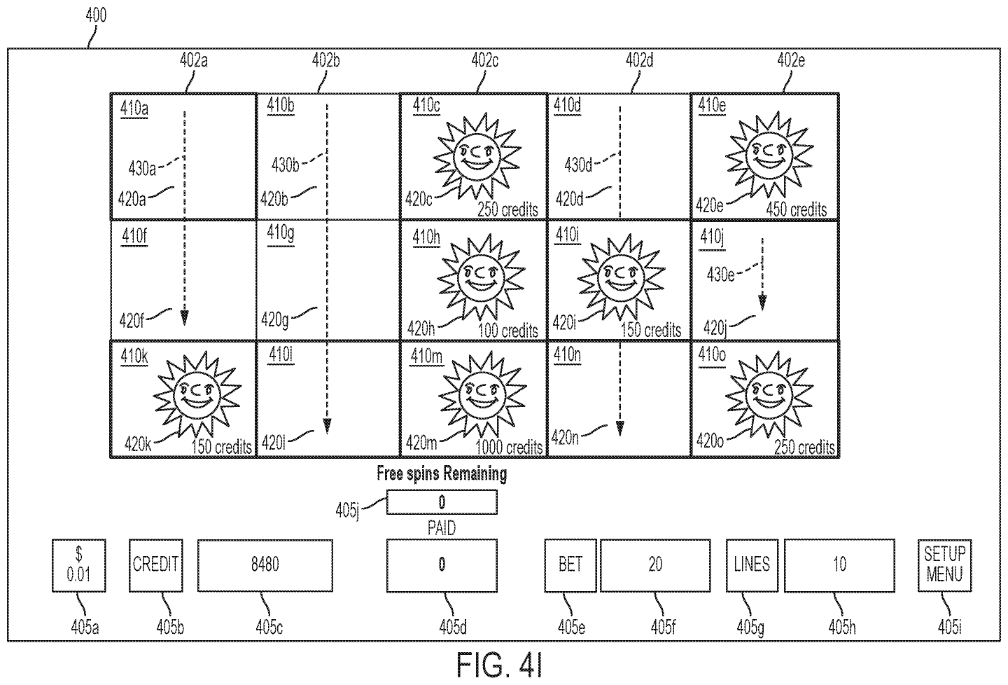

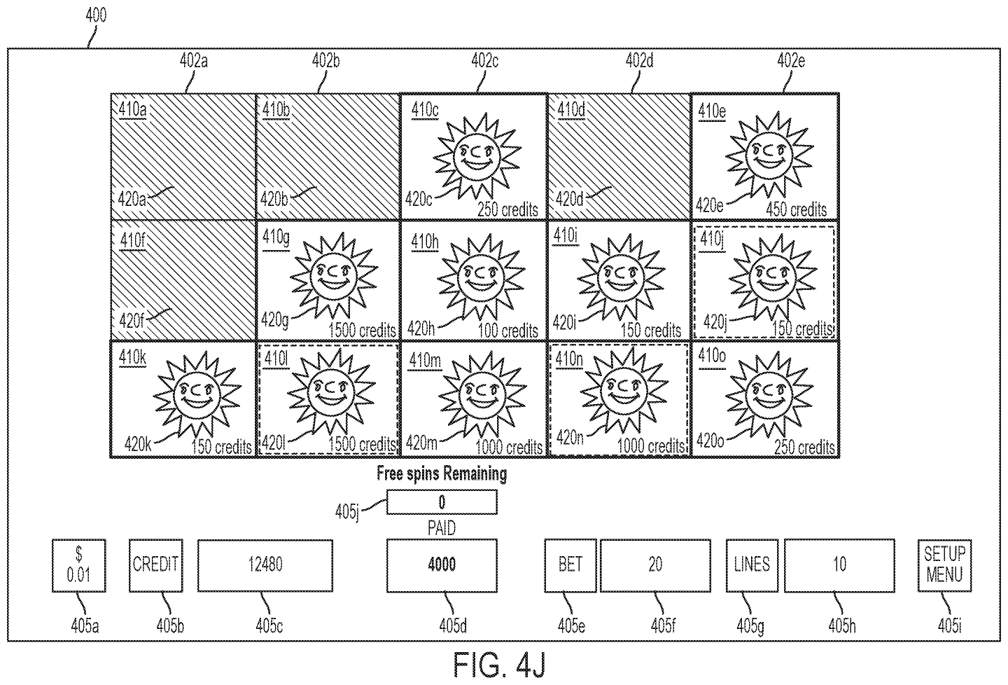

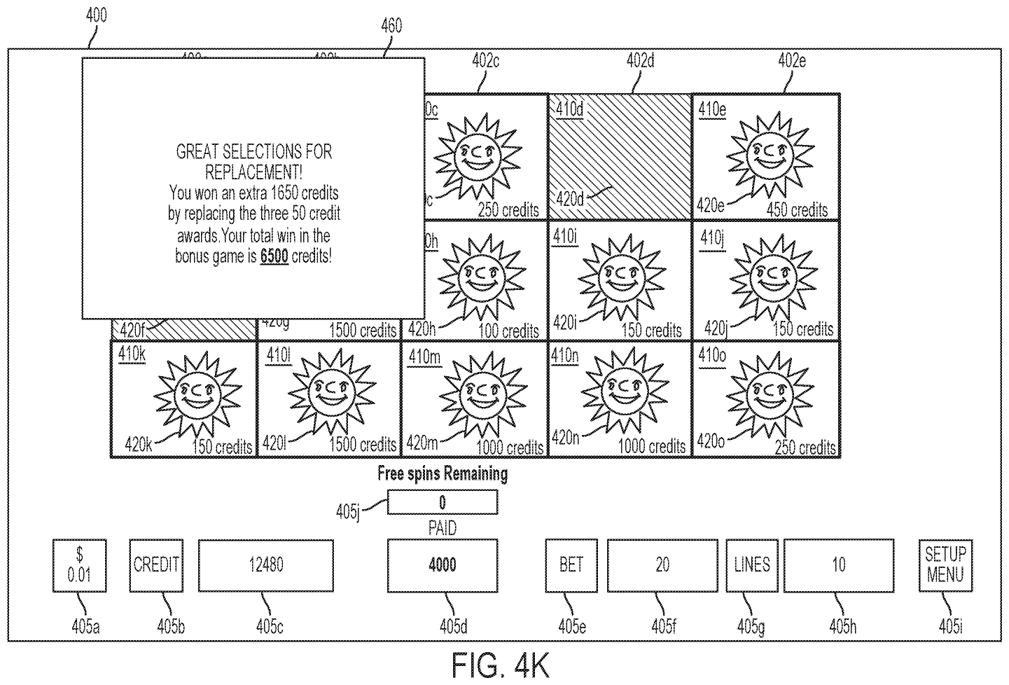

FIGS. 4A-4K illustrate screen shots of one embodiment of a gaming system that enables partial replacements of offered awards.

FIG. 4A illustrates one embodiment of a game display 400 that the gaming device 100 may display on a display device of the gaming system. In one embodiment, game display 400 may be displayed on first display 122 of gaming device 100 illustrated in FIG. 1. However, any other suitable display may be used. The game display 400 displays a set of a plurality of virtual video slot machine reels 402a, 402b, 402c, 402d, and 402e as illustrated in FIG. 4A for a primary or base game. As also illustrated in FIG. 4A, the reels 402a-402e are displayed substantially side by side. It should be appreciated that reels 402a-402e can be displayed with any suitable amount of separation or no separation. It should be appreciated that the game shown in game display 400 is merely representative and may have more or fewer game elements (e.g., reels, symbol display areas, symbols, etc.) shown in the game display 400. It should also be appreciated that other games may be used for the primary or base game.

The plurality of reels 402a-402e are each associated with a set of symbols, where each set of symbols includes a plurality of symbols. Each set of symbols can be associated with the same or a different plurality of symbols. The sets of symbols may include numbers, letters, geometric figures, symbols, images, character, blank symbols (e.g., the absence of symbols), animations, transparent symbols (e.g., symbols that permits underlying symbols to be visible), or any other suitable graphical depiction. The symbols in the set of symbols may include pay symbols and special or designated symbols. In one embodiment, at least one predetermined symbol is a triggering symbol for a bonus game. In one embodiment, at least one triggering symbol must be generated on the reels during a play of a game to trigger the bonus game. In some embodiments, a plurality of triggering symbols must be generated on the reels during a play of a game to trigger the bonus game. In one embodiment, any one of the symbols in the sets of symbols can be designated as the predetermined triggering symbol. The triggering symbol may be associated with one function (e.g., triggering a bonus game), but may alternatively be associated with a plurality of different game functions. The triggering symbol may be a scatter symbol in some embodiments.

Returning now to FIG. 4A, the game display 400 depicts a plurality of symbol display areas (also referred to herein as symbol display positions) 410a, 410b, 410c, 410d, 410e, 410f, 410g, 410h, 410i, 410j, 410k, 410l, 410m, 410n, and 410o. These plurality of symbol display areas can be associated in a manner that provides the appearance of game reels. It should also be appreciated that the symbol display areas may not be associated with game reels in some embodiments. As illustrated in FIG. 4A, symbol display areas 410a, 410b, 410c, 410d, 410e, 410f, 410g, 410h, 410i, 410j, 410k, 410l, 410m, 410n, 410o are associated in a manner that provides the appearance of a set of five slot machine game reels. In one embodiment, the plurality of symbol display areas that provide the appearance of five game reels may be arranged in a manner that visibly shows three symbol positions of each of the five game reels. For example, the symbol display areas 410a-410o are each associated with positions on reels 402a-402e, respectively. As shown in FIG. 4A, symbol display areas 410a, 410f, and 410k are associated with reel 402a; symbol display areas 410b, 410g, and 410l are associated with reel 402b; symbol display areas 410c, 410h, and 410m are associated with reel 402c; and symbol display areas 410d, 410i, and 410n are associated with reel 402d; and symbol display areas 410e, 410j, and 410o are associated with reel 402e. The arrangement illustrated in the embodiment of FIG. 4A thus creates a visible display area of the reels 402a-402e comprising three visible symbol positions for each reel. When viewed together, reels 402a-402e appear like a 3-row by 5-column reel array in display 400. In other embodiments, smaller or larger visible areas of the reels can be displayed. That is, the reels 402a-402e may show fewer or a larger number of visible symbol display areas. While symbol display areas are illustrated with defined boxes, it should be appreciated that in some embodiments, the defined boxes are not visible to the player. It should also be appreciated that in some embodiments, the symbol display areas are other shapes or not defined shapes and may not be associated with reels.

Each reel 402a-402e may display a plurality of symbols that the gaming system generates from the sets of symbols in their respective symbol display areas as illustrated in FIG. 4A. In one embodiment, the reels may be shown spinning in one direction to simulate slot machine reels. However, it should be appreciated that the reels may be shown spinning in any suitable direction. The reels may also be shown spinning in different directions in some embodiments.

Game display 400 also includes several information areas and buttons 405a-405i. These information areas and buttons 405a-405i are illustrated in a particular arrangement, but may be arranged in any suitable manner in different embodiments. In some embodiments, game display 400 may include more or fewer display areas and buttons 405a-405i than illustrated. Information area 405a illustrates an example value of one credit for the game displayed in game display 400. Information areas 405b and 405c illustrate an example of the amount of the player's available credits. Information area 405d illustrates the amount of credits a player has won. Because FIG. 4A illustrates the start of a play of a game, the information area 405d shows zero credits have been won. Button 405e illustrates a software button that the player can select to place a bet or wager. It should be appreciated that the functionality of button 405e may also be replicated or replaced with a hardware button on the gaming device 100. Information area 405f illustrates that the player has selected to wager 200 credits by selecting to wager 20 credits on 10 pay lines. Button 405g illustrates a software button that the player can select to determine how many pay lines to wager on. It should be appreciated that the functionality of button 405g may also be replicated or replaced with a hardware button on the gaming device 100. Information area 405h illustrates that the player selected to wager on 10 pay lines. Button 405i illustrates a software button that the player can select to obtain information about the game, change certain aspects of the game, obtain help, place an order, etc.

To start a gaming session, a player provides the gaming system with a deposit of value, using one of the suitable mechanisms discussed above. The gaming system receives and validates the player's deposit of value. The gaming system can then issue credits (or gaming credits) to the player based on the received value. The credits enable the player to initiate a play of a game and to also place wagers on a play of the game. The gaming system may provide a visual indication of the player's credit balance to the player as discussed above in information area 405c.

To initiate a play of a game, the player activates or presses one or more appropriate buttons on the gaming system to deduct credits necessary to play the game and to identify the player's wager. Along with receiving the player's wager, the gaming system may receive pay line selections or other game functions the player wishes to activate in exchange for the wager. The player may also actuate a game start button, a spin button, or a lever. The gaming system may deduct the appropriate credits from the player's credit balance after the wager or at any suitable time.

Upon receipt of the player's wager and activation of the game start button, the gaming system may show a display of spinning reels for each of the reels 402a-402e. The spinning may appear to occur in a vertical top to bottom direction or in a vertical bottom to top direction (not shown), or in a combination of vertical directions (not shown). In one embodiment, the gaming system randomly generates symbols from the associated sets of symbols for reels 402a-402e, respectively. As noted above, the gaming system may rely on random generation performed by a pseudo RNG, a true RNG, or hardware RNG specifically designed for gaming systems. In one embodiment, the gaming system may also update the player's credit meter (information area 405c) to reflect the player's available credit balance. As shown in FIG. 4A, the player's credit meter (information area 405c) was decremented by 200 credits from 2180 to 1980 to reflect the 200 credit wager the player placed for the play of the game.

The gaming system displays the generated symbols 420a-420o in symbol display areas 410a-410o as illustrated in FIG. 4A. Symbols 420a-420o displayed on reels 402a-402e illustrate the randomly generated symbols from the set of symbols after the reels have stopped spinning. As illustrated in FIG. 4A, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h, and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e.

As illustrated in FIG. 4A, the gaming system generated and displayed Grape symbols (420a, 420b, 420c, 420d, 420e, 420k), Sun symbols (420f, 420g, 420h, 420o), a Seven symbol (420i), Cherry symbols (420j, 420l), a Queen symbol (420m), and an Apple symbol (420n) in the game display 400. It should be appreciated that the displayed symbol combinations are merely for explanatory purposes and the gaming system may randomly generate any suitable combination of symbols based on defined symbol sets associated with the reels 402a-402e.

FIG. 4A further illustrates one embodiment of a gaming system executing an evaluation of the generated symbols on reels 402a-402e for winning symbol combinations. As noted above, the player may have wagered on one or more pay lines (such as 10 pay lines shown in information area 405h). In one embodiment, at least the active (wagered on pay lines) are evaluated for winning symbol combinations. Any suitable number of pay lines may be used to evaluate winning symbol combinations.

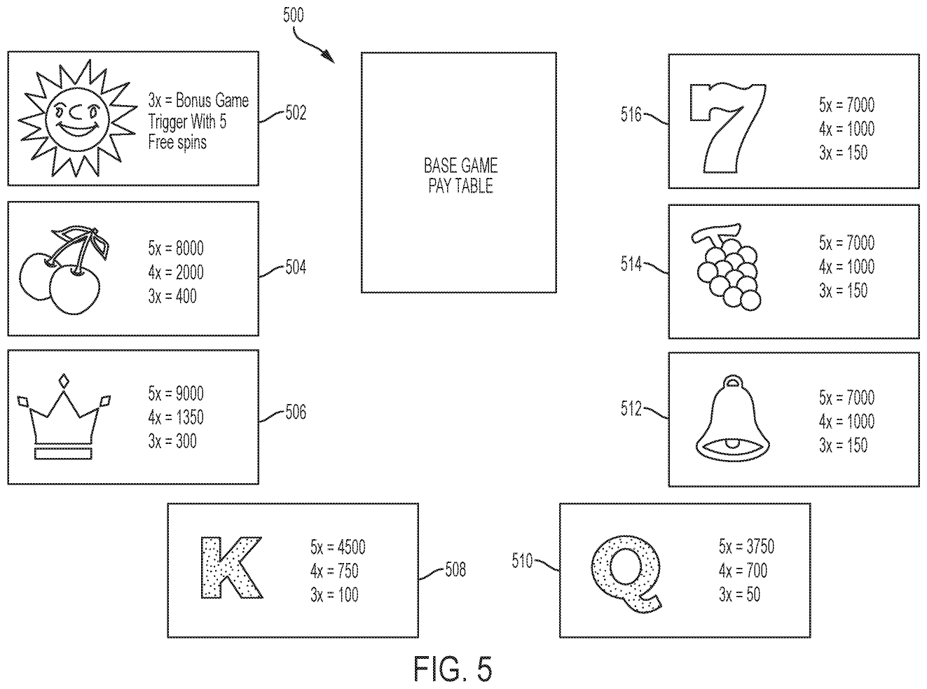

In the embodiment illustrated in FIG. 4A, the gaming system evaluated the generated symbol combinations for winning symbol combinations. In FIG. 4A, the gaming system determined that a winning symbol combination is displayed across one wagered pay line. The pay line spans across a horizontal direction of symbol display areas including symbol display areas 410a, 410b, 410c, 410d, and 410e. In this embodiment, the gaming system displayed five Grape symbols along a horizontal pay line on which the player had placed a wager. The gaming system determined the five Grape symbols form a winning symbol combination based on a pay table associated with the gaming system (such as the base game pay table in FIG. 5). The winning pay line is illustrated as pay line 445 in FIG. 4A across the row of reels 402a-402e.

As noted at block 355 of FIG. 3B, in one embodiment, the gaming system may also evaluate the generated symbols on reels 402a-402e for triggering symbols that trigger a bonus game. As illustrated in FIG. 5, a bonus game is triggered when at least three Sun symbols are generated along a pay line. The three Sun symbols also provide three free spins for the bonus game. In some embodiments, the gaming system provides spins for the bonus game in exchange for some value from the player. For example, the player may be required to wager at a certain predetermined level or play the game over a certain period of time. In some embodiments, the gaming system may require the player to wager a predetermined amount to obtain the three spins for the bonus game.

Returning to FIG. 4A, the gaming system determined that three Sun symbols (420f, 420g, and 420h) were generated for the play of the game along wagered pay line 447. In the illustrated embodiment, the Sun symbol was designated as the bonus game triggering symbol. It should be appreciated that any other suitable symbol could be designed as the bonus game triggering symbol. In some embodiments, more than one different symbol can be designated as a bonus triggering symbol. In some embodiments, a combination of different triggering symbols along a pay line may be required to trigger a bonus game. In some embodiments, a predetermined quantity of scatter symbols can be used as a bonus game trigger. In some embodiments, the scatter symbols do not need to appear on a wagered pay line to trigger the bonus game. In some embodiments, the Sun symbols may be scatter symbols that trigger a bonus game. In some embodiments, the gaming system may highlight the Sun symbols in some manner (not shown) so that player understands that the player won a bonus game or other game features. It should be appreciated that the gaming system may highlight the bonus triggering symbol in any suitable manner. It should also be appreciated that the gaming system may not highlight the bonus triggering symbols in some embodiments, as is illustrated in FIG. 4A.

In some embodiments, the gaming system may be required to generate more than one bonus triggering symbol to activate a bonus game (as shown in pay table of FIG. 5). In other embodiments, the features available in the bonus game may depend on the quantity of bonus triggering symbols that the game system generates. In one embodiment, at least one bonus trigging symbol must be generated in the far most reel 402a (in any symbol display area) to trigger the bonus game. That is, if the at least one bonus triggering symbol is generated in reels 402b, 402c, 402d, or 402e, (but not in reel 402a) the gaming system may not activate the bonus game. However, in other embodiments, the bonus triggering symbol may appear on any reel in any symbol display area to trigger the bonus game. In some embodiments, the gaming system may evaluate the bonus triggering symbols from a left to right direction along the reels. In some embodiments, the gaming system may evaluate the bonus triggering symbols from a right to left direction along the reels.

Returning to FIG. 4A, the gaming system determined that three triggering symbols (the Sun symbols 420f, 420g, and 420h) were generated on reels 402a, 402b, and 402c in symbol display areas 410f, 410g, and 410h. Based on the generated bonus triggering symbol on such reels along wagered pay line 447, the gaming system activates a bonus game.

In one embodiment, the gaming system uses the same symbol sets associated with the same reels for both the primary game and the bonus game, but changes the pay table for the bonus game. As illustrated in FIG. 6, the gaming system switches to a pay table 600 that provides pays for Sun symbols generated in a certain manner. Unlike the pay table in FIG. 5, the FIG. 6 pay table 600 indicates that Sun symbols can be awarded a plurality of different values from table 604. Pay table 600 also indicated that when Sun symbols are generated in the bonus game, the Sun symbol will be frozen (or persistent) in its displayed location for the duration of the bonus game. An award value associated with a Sun symbol is displayed and offered to the player when a displayed frozen Sun symbol is directly adjacent to (e.g., touching) at least one other displayed frozen Sun symbol. In other words, Sun symbols pay when Sun symbols are generated in contiguous blocks (or groups) of Sun symbols in the symbol display areas. For example, directly adjacent or touching means that the gaming system generated a Sun symbol that shares at least one symbol display area border with another symbol display area border that includes a generated Sun symbol. As a more specific example, directly adjacent or touching means that the gaming system generated a Sun symbol in symbol display area 410h and also at least one other Sun symbol in symbol display areas 410c, 410i, 410g, or 410m. These two directly adjacent Sun symbols would create a contiguous block or group of Sun symbols. However, as noted above in FIGS. 3A-3D, in some embodiments, an award value associated with a Sun symbol is displayed and offered to the player when the gaming system generates and displays the Sun symbol during a spin of the bonus game. It should be appreciated that in some embodiments, touching does not require Sun symbols to actually touch each other. For example, the Sun symbols can be positioned substantially close to each other, but not actually touch to be part of a contiguous block or group.

In some embodiments, the gaming system generates and assigns an award value from table 604 to each Sun symbol in each set of symbols associated with the respective reels 402a-402e. These award values can be assigned before, during, or after the Sun symbols are generated for display in the bonus game. In one embodiment, as the gaming system generates a Sun symbol for display in the bonus game, the gaming system also generates an associated award value from table 604. In some embodiments, award values associated with generated and displayed Sun symbols are not shown to the player unless the displayed Sun symbols are in a contiguous block of at least two Sun symbols. Thus, in some embodiments, the player is not shown (or offered) the award value associated with a standalone Sun symbol (e.g., a Sun symbol not in a contiguous block or touching any other Sun symbol). In some embodiments, the award values associated with a generated and displayed Sun symbols are shown and offered to a player when the Sun symbols are displayed in symbol display areas, regardless of whether the Sun symbols are part of a contiguous block of at least two Sun symbols.

Turning now to FIG. 4B, the gaming system in one embodiment provides the player with information regarding all of the awards for the play of the base game. In this embodiment, the gaming system alerts the player that the player won 7000 credits, a bonus game, and three free spins in the bonus game. In some embodiments, the gaming system may break down how the player won the credits and free spin bonus game. For example, the gaming system may describe that the five Grape symbols along a wagered pay line pays 7000 credits (e.g., based on the pay table illustrated in FIG. 5). The gaming system may also indicate that Sun symbols trigger the bonus game. It should be appreciated that the quantity of free spins may be predetermined or randomly generated. In some embodiments, the quantity of awarded free spins may be based on the player's wager, where higher wagers may result in a greater quantity of free spins than lower wagers. It should be appreciated that in some embodiments, the obtaining greater quantities of Sun symbols in the base game along a wagered pay line may result in a greater number of free spins. It should also be appreciated that the awards illustrated in FIG. 4B and FIG. 5 are merely illustrative and could be adjusted to include any suitable awards and different credit amounts. In some embodiments, spins may not be free and may require a wager or some payment to obtain the spins.

As illustrated in FIG. 4B, the gaming system awards the appropriate number of credits to the player and updates the player's win meter (shown in information area 405d) to reflect the player's winnings during the play of the base game. In one embodiment, the gaming system may also update the player's credit meter (information area 405c) to reflect the player's available credit balance.

If the player did not win a bonus game, the player may continue the gaming session by playing another play of the game. That is, the player may place another wager and start a new play of the game, as noted above. However, continued game play is dependent of the number of credits remaining in the player's credit balance. The player may also choose to cash out. In such an instance, the gaming system provides the player a value based on the player's credit balance using any of the value items discussed above (bills, coins, vouchers, etc.).

FIG. 4C illustrates one embodiment where the player won a bonus game with free spins. In one embodiment, the gaming system may automatically start the bonus game and executes the free spins (to generate a new plurality of symbols for display on the reels), where each free spin is a play of the bonus game (which occurs within a play of the game). In one embodiment, the gaming system may automatically continue executing the available free spins until no free spins remain. In one alternative embodiment, the gaming system may enable the player to manually start one or more free spins in the bonus game. FIG. 4C further illustrates each of reels 402a-402e spinning for a first generation of symbols on the reels. Spin direction 430a, 430b, 430c, 430d, and 430e illustrate the spin direction of the reels in FIG. 4C. Free spin balance meter 405j also shows the player how many free spins remain in the bonus game. The gaming system updated the player's win meter (shown in information area 405d) to reflect that the player has not yet won any awards during the bonus game.

As illustrated in FIG. 4D, the gaming system randomly generated symbols 420a-420o from the sets of symbols associated with reels 402a-402e, respectively. As noted above, the gaming system may rely on random symbol generation performed by a pseudo RNG, a true RNG, or hardware RNG to generate the symbols for the bonus game. In one embodiment, the gaming system may also update the player's free spin balance meter (information area 405j) to reflect the player's available free spin balance. In the bonus game with free spins, the player's credit meter will generally either increase or remain the same, depending on winning outcomes. For example, the gaming system may award the player with additional free spins for certain game outcomes, such as obtaining a predetermined quantity of contiguous Sun symbols. In some bonus game embodiments, it should be appreciated that the player may use additional credits for some aspect of a bonus game.

The gaming system displays the generated symbols 420a-420o in symbol display areas 410a-410o as illustrated in FIG. 4D. Symbols 420a-420o displayed on reels 402a-402e illustrate the randomly generated symbols after the reels have stopped spinning. As illustrated in FIG. 4D, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h, and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e. For purposes of illustration, symbols 420a-420g, 420k, 420l, 420n, and 420o are obscured from view because these symbols were not Sun symbols and accordingly did not provide a payout award according to the bonus pay table in FIG. 6. In some embodiments, the symbols 420a-420g, 420k, 420l, 420n, and 420o may be partially visible or completely visible. In some embodiments, some or all symbols that are not Sun symbols are removed from the symbol sets associated with the reels for the bonus game. Thus, the gaming system may generate only blank symbols and Sun symbols on the reels in some embodiments.

As illustrated in FIG. 4D, the gaming system generated and displayed Sun symbols (420h, 420i, 420j, and 420m) in symbol display areas 410h, 410i, 410j, and 410m in the game display 400. It should be appreciated that the displayed symbol combinations are merely for explanatory purposes and the gaming system may randomly generate any suitable combination of symbols based on defined symbol sets associated with their respective reels. In one embodiment, as illustrated in the pay table of FIG. 6, the Sun symbols were designated as pay symbols when meeting certain conditions. As previously noted, the Sun symbols are also persistent symbols or freeze symbols, which generally remain in the symbol display area during the bonus game once generated and displayed during a free spin of the bonus game. It should be appreciated that any suitable symbol can be designated as the persistent symbol, freeze symbol, or frozen symbol. More than one symbol can be designated as the persistent symbol in some embodiments.

FIG. 4D illustrates that the gaming system randomly generated and associated award values from table 604 with each of the generated and displayed Sun symbols. The generated and displayed Sun symbols display their associated award values when the Sun symbols are displayed as part of a contiguous group of Sun symbols. As illustrated in FIG. 4D, Sun symbol 420h, 420i, 420j, and 420m are part of a contiguous group of Sun symbols (they are each connected to another Sun symbol/directly adjacent to another Sun symbol in an adjacent symbol display area). Thus, the gaming system displays an award value of 100 credits associated with Sun symbol 420h, an award value of 150 credits associated with Sun symbol 420i, an award value of 50 credits associated with Sun symbol 420j, and an award value of 1000 credits associated with Sun symbol 420m (e.g., values randomly generated and associated with the respective Sun symbols from table 604). In the illustrated embodiment of FIG. 4D, the gaming system offers the displayed award values associated with the displayed Sun symbols to the player. That is, if the gaming system did not generate any additional Sun symbols for the remainder of the spins of the bonus game (or the player cashed out at this stage of the bonus game), the player would obtain all of the displayed award values (totaling 1300 credits for the player's offered bonus award).

As noted above, once a Sun symbol is generated and displayed during a spin of the bonus game, the Sun symbol will remain displayed for the remainder of the spins of the bonus game. As such, Sun symbols, 420h, 420i, 420j, and 420m are persistently displayed on display device 400 through each remaining free spin of the bonus game. In subsequent free spins of the bonus game, the player hopes that the gaming system will generate additional Sun symbols that are connected to already displayed Sun symbols 420h, 420i, 420j, and 420m to improve the player's bonus award. In some embodiments, the gaming system may execute an evaluation of the generated symbols on reels 402a-402e for winning symbol combinations (e.g., connected Sun symbols) and update information area 405d after each free spin. In other embodiments, as is illustrated in FIGS. 4A-4K, the gaming system may wait until all free spins have been exhausted before updating information area 405d with the player's offered bonus award for the bonus game.

Turning to FIG. 4E, the gaming system executes another free spin of the bonus game. Specifically, FIG. 4E illustrates each of reels 402a-402e spinning for a second generation of symbols on the reels. Spin direction 430a, 430b, 430c, 430d, and 430e illustrate the spin direction of the reels in FIG. 4E. The gaming system updated free spin balance meter 405j to show the player that two free spins remain in the bonus game. Persistent Sun symbols 420h, 420i, 420j, and 420m remain displayed through the new free spin of the bonus game round.

While not illustrated in FIG. 4E, in one embodiment, the spinning reels 402a-402e are fully spinning (not just for symbol display areas without persistent Sun symbols) and can generate new symbols for each symbol display area 410a-410o, even where a persistent Sun symbol is already displayed). Thus, in some embodiments, a displayed persistent Sun symbol is formed as a layer over the reels 402a-402e. In some such embodiments, the reel strip (or the set of symbols for a reel) is not altered by a persistent Sun symbol in symbol display area. That is, a reel can generate and display another persistent Sun symbol in a different symbol display area based on the same Sun symbol that was used to create a displayed persistent Sun symbol. Yet in other embodiments, the reel strip can be modified to remove any Sun symbols that have been persistently displayed on the reels. In such embodiments, the removed Sun symbols from a reel strip not available for additional generation in later spins of the bonus game for the play of the game.

In some embodiments, once a Sun symbol has been generated in a symbol display area, even if the gaming system generates new symbols in the same symbol display area for subsequent free spins in a bonus game, the gaming system will not replace the existing displayed Sun symbol. For example, even if the gaming system generated a new symbol for symbol display area 410h for the second free spin, the gaming system will not replace the Sun symbol with another Sun symbol or any other symbol. It should be appreciated that other embodiments are possible where the gaming system can replace a persistent Sun symbol that has already been displayed, as will be discussed below in more detail. For example, the gaming system may replace a lower value Sun symbol with a higher value Sun symbol in a particular symbol display area to improve the player's award in some embodiments.

As illustrated in FIG. 4F, the gaming system randomly generated symbols 420a-420o from the sets of symbols associated with reels 402a-402e, respectively. As noted above, the gaming system may rely on random symbol generation performed by a pseudo RNG, a true RNG, or hardware RNG to generate the symbols for the bonus game. In one embodiment, the gaming system may also update the player's free spin balance meter (information area 405j) to reflect the player's available free spin balance if it was not already updated.

The gaming system displays the generated symbols 420a-420o in symbol display areas 410a-410o as illustrated in FIG. 4F. Symbols 420a-420o displayed on reels 402a-402e illustrate the randomly generated symbols after the reels have stopped spinning. As illustrated in FIG. 4F, the gaming system randomly generated and displayed symbols 420a, 420f, and 420k in symbol display areas 410a, 410f, and 410k for reel 402a. The gaming system also randomly generated and displayed symbols 420b, 420g, and 420l in symbol display areas 410b, 410g, and 410l for reel 402b; symbols 420c, 420h, and 420m in symbol display areas 410c, 410h, and 410m for reel 402c; symbols 420d, 420i, and 420n in symbol display area 410d, 410i, and 410n for reel 402d; symbols 420e, 420j, and 420o in symbol display area 410e, 410j, and 410o for reel 402e. As noted above, for purposes of illustration, symbols 420a, 420b, 420d, 420f, and 420g are obscured from view because these symbols were not Sun symbols and accordingly did not provide a payout award according to the bonus pay table in FIG. 6. In some embodiments, the symbols 420a, 420b, 420d, 420f, and 420g may be partially visible or completely visible. In some embodiments, the gaming system may use a pay table that provides awards to various symbol combinations (similar to the symbol combination awards shown in FIG. 5 in addition to the Sun symbol combination awards).

As illustrated in FIG. 4F, the gaming system generated and displayed new Sun symbols 420c, 420e, 420k, 420l, 420n, and 420o in symbol display areas 410c, 410e, 410k, 410l, 410n, and 410o that add to the previously generated Sun symbols 420h, 420i, 420j, and 420m in symbol display areas 410h, 410i, 410j, and 410m in the game display 400. As illustrated in FIG. 4F, Sun symbol 420c, 420e, 420h, 420i, 420j, 420k, 420l, 420m, 420n, and 420o are all part of a contiguous group of Sun symbols (they are each connected to another Sun symbol/directly adjacent to another Sun symbol in an adjacent symbol display area). Thus, Sun symbols 420c, 420e, 420h, 420i, 420j, 420k, 420l, 420m, 420n, and 420o are respectively assigned the award values of 250, 450, 100, 150, 50, 150, 50, 1000, 50, and 250 credits. Sun symbols, 420c, 420e, 420h, 420i, 420j, 420k, 420l, 420m, 420n, and 420o are also persistently displayed on display device 400 through each remaining free spin of the bonus game. In subsequent free spins, the player hopes that the gaming system will generate additional Sun symbols that are connected to already displayed Sun symbols 420c, 420e, 420h, 420i, 420j, 420k, 420l, 420m, 420n, and 420o to improve the player's award.

In some embodiments, the gaming system evaluates all symbols generated and displayed for this free spin illustrated in FIG. 4F. However, in some embodiments, the gaming system skips evaluating symbols that are not Sun symbols. By skipping evaluation of all of the generated and displayed symbols, the efficiency of the gaming system can be improved because less memory and less processing power is used during the gaming system's evaluation after each free spin. This efficiency also translates into faster game play because less time is used to complete the game's evaluation. When such efficiency improvements are made and applied to the hundreds and thousands of games evaluations that are made on a casino floor during a given period of time for the disclosed gaming system, the new gaming system will provide casino game operators sizable gains in machine efficiency.

In one embodiment, if less than the predetermined quantity of spins remain in the bonus game, the gaming system may offer the player a chance to risk some or all of the offered award values for a chance to obtain improved award values. In the embodiment illustrated in FIG. 4G, the gaming system determined that less than two spins remain in the bonus game. In FIG. 4G, the gaming system displayed a message 450 to the player. As illustrated in FIG. 4G, the gaming system offered the player the ability to select any displayed offered award value (e.g., any displayed Sun symbol) for removal and a chance to obtain new Sun symbols and improve the offered award values. In one embodiment, the player may select button 451 or button 452 to indicate to the gaming system whether the player wishes to risk any currently offered award values. It should be appreciated the gaming system may receive the player's indication in any suitable manner using any suitable input device of the gaming system.

Turning to FIG. 4H, display 400 of the gaming system illustrates at the player has selected three displayed Sun symbols for replacement. It should be appreciated that the gaming system enables the player to select Sun symbols, the award values, or the associated symbol display areas. For example, cursor 456 illustrates the player selecting Sun symbol 420j for replacement. FIG. 4H also illustrates the player selecting Sun symbol 420n and Sun symbol 420l with cursor 457 and cursor 458. These Sun symbols 420n and 420l will also be replaced. In some embodiments as illustrated in FIG. 4H, the gaming system may indicate or highlight to the player which Sun symbol selections a player has made. However, it should be appreciated the gaming system may not highlight the player's selections in some embodiments. As illustrated in FIG. 4H, the player selected the three lowest offered award values for removal. As noted above, the gaming system may enable the player to select any of the displayed offered award values. For example, if the player was less risk-averse, the player may have selected additional offered award values such as the offered 150 credit award values. In some embodiments, the player may select all offered award values (e.g., displayed Sun symbols). In some embodiments, where more than one spin in the bonus game is available, the player may strategically select additional lower credit award values knowing that the player has more than one additional opportunity to improve the existing lower value offered award values. In some embodiments, the gaming system limits the quantity of Sun symbols the player may select for removal. In some embodiments, the gaming system provides the player a predetermined quantity of selections that can be used throughout the bonus game. For example, if the gaming system provided five selections to use during the bonus game, the player may decide to use one of the selections during an early part of the bonus game (e.g., after a first or second spin), but save the remaining selections for the after the second to last spin of the bonus game. The player may determine the best time strategically to use the selections during the bonus game.

As illustrated in FIG. 4I, the gaming system executed the final remaining free spin of the bonus game. Specifically, FIG. 4I illustrates each of reels 402a-402e spinning for a third and final generation of symbols on the reels. Spin direction 430a, 430b, 430d, and 430e illustrate the spin direction of the reels in FIG. 4I. The gaming system updated free spin balance meter 405j to show the player that zero free spins remain in the bonus game. Persistent Sun symbols 420c, 420e, 420h, 420i, 420k, 420m, and 420o remain displayed through the new free spin of the bonus game round. As illustrated in FIG. 4I, the gaming system also removed the player selected Sun symbols in symbol display areas 410j, 410l, and 410n. With the player selected Sun symbols removed, the gaming system can potentially generate new Sun symbols for symbol display areas 410j, 410l, and 410n that are associated with higher award values than were displayed in FIG. 4H. The gaming system may also generate Sun symbols for the other symbol display areas that did not previously obtain Sun symbols.

As illustrated in FIG. 4J, the gaming system displayed the generated symbols 420a-420o in symbol display areas 410a-410o. Symbols 420a-420o displayed on reels 402a-402e show the randomly generated symbols after the reels have stopped spinning. As can be seen in FIG. 4J, the gaming system generated and displayed replacement Sun symbols in symbol display area 410j, 410l, and 410n. The displayed replacement Sun symbols in symbol display areas (410j, 410l, and 410n) are associated with much higher award values than the Sun symbols previously displayed in these symbol display areas. Specifically, the gaming system generated replacement Sun symbols associated with offered award values of 150 credits, 1500 credits, and 1000 credits to replace the three previously displayed 50 credit award values. The gaming system further generated a new Sun symbol in symbol display area 410g, which is also associated with a 1500 credit award value. In other words, enabling the player to risk offered award values (portions of the player's offered bonus award), enables the player to potentially greatly improve the player's offered bonus award. As also illustrated in FIG. 4J, the gaming system may highlight the replacement Sun symbols to the player in any suitable manner.

As illustrated in FIG. 4K, the gaming system displayed a message 460 to the player indicating that the player made great award value selections for replacement. The message may indicate that the player added an additional award value (e.g., 1650 credits) for a total bonus win of 6500 credits. In some embodiments, the gaming system may alert the player that not selecting the three offered award values would have provided lower value awards and a lower value offered bonus award, further enhancing the player's satisfaction with the game.

In the illustrated embodiment, no free spin games remain. Therefore, the gaming system does not generate additional symbols for symbol display areas in the bonus game. The play of the game ends. The player may continue to play additional games or cash out as discussed in connection with FIGS. 3A-3D. In some embodiments, as discussed above, the gaming system may offer the player the ability to purchase additional selections for removal and at least one additional spin of the bonus round.

FIG. 5 illustrates a screen shot of one embodiment of a pay table 500 for a base game of the gaming system. Tables 502, 504, 506, 508, 510, 512, 514, and 516 are merely example payout awards for example symbol combinations. As noted above, it should be appreciated that the pay table is merely illustrative, and the symbols, awards, and the credit values may all be modified in any suitable manner.

FIG. 6 illustrates a screen shot of one embodiment of a pay table for a bonus game of the gaming system. As noted above, it should be appreciated that the pay table is merely illustrative, and the symbols, awards, and the credit values may all be modified in any suitable manner.

In some embodiments of the gaming system with free spins, the gaming system may award additional free spins when certain conditions occur with persistent symbols. For example, on any spin of the game, if a predetermined quantity of persistent symbols are generated and displayed, the gaming system may award three additional free spins to the player's free spins balance. Any suitable quantity of additional free spins can be added. The predetermined quantity of generated persistent symbols may also be assigned any suitable number, such as three or four persistent symbols during a spin of a play of the game. In some embodiments, the gaming system awards a jackpot award if the player obtains persistent symbols in every displayed symbol display area. In some embodiments, the jackpot is funded by portions of every play of a game. However, the jackpot can be funded in any suitable manner.

Based on the forgoing description, it should be appreciated that a gaming system and method with improvements to game outcomes with near misses creates new and very exciting ways for a player to obtain improved winnings with a potential to earn frequent and greater awards or to turn a losing gaming into a winning game. Such a potential to earn greater awards creates a greatly improved sense of anticipation for players.

A number of embodiments of the invention have been described. Various modifications may be made without departing from the spirit and scope of the invention. For example, various forms of the flows shown above may be used, with steps re-ordered, added, or removed. Accordingly, other embodiments are within the scope of the following claims.

We claim:

1. A gaming system comprising:
a processor;
a display device;
an input device;
a dispenser;
a random number generator;
a memory device that stores a plurality of instructions which, when executed by the processor, cause the processor to:
randomly generate, using the random number generator, a first plurality of symbols, where the first plurality of symbols comprises a plurality of persistent symbols and a plurality of non-persistent symbols;
display, using the display device, the first plurality of symbols in a plurality of symbol display areas, each of the first plurality of symbols being associated with a separate one of the plurality of symbol display areas;
display, using the display device, a plurality of offered award values, where each of the plurality of offered award values is associated with one of the displayed plurality of persistent symbols;
receive, via the input device, at least one selection of at least one symbol display area associated with one of the plurality of displayed persistent symbols;
remove, from the display device, a displayed persistent symbol and an associated offered award value from the selected symbol display area;
randomly generate, using the random number generator, a second plurality of symbols for the plurality of symbol display areas, wherein each of the second plurality of symbols is associated with a separate one of the plurality of symbol display areas, where the second plurality of symbols comprises a second plurality of persistent symbols and a second plurality of non-persistent symbols;
display, using the display device, at least one new persistent symbol in the selected symbol display area and a subset of the second plurality of symbols, where the second plurality of symbols replaces the displayed first plurality of symbols in the associated symbol display areas without replacing any displayed persistent symbols from the first plurality of symbols in the associated symbol display areas;
determine one or more awards based on values of any of the persistent symbols displayed on the display device;
display, using the display device, the one or more awards based on the values of any displayed persistent symbols, the credit balance being increased by any determined awards; and
issue, using the dispenser, a value based on the one or more awards credit balance upon receipt of a cash out signal via a second input device.

2. The gaming system of claim 1, wherein the processor further determines if any displayed persistent symbol is not adjacent to at least one other displayed persistent symbol.

3. The gaming system of claim 1, wherein the any determined awards are further based on values of the any displayed persistent symbols that are adjacent to at least one other displayed persistent symbol.

4. The gaming system of claim 1, wherein, except if selected for removal, any displayed persistent symbols from the first plurality of symbols and the second plurality of symbols remain displayed, and
displaying a subset of a third plurality of symbols for the plurality of symbol display areas.

5. The gaming system of claim 1, wherein the processor further:
receives a plurality of selections of the plurality of symbol display areas associated with displayed persistent symbols, and
removes, from each of the plurality of selected symbol display areas, an associated displayed persistent symbol and offered award value.

6. The gaming system of claim 5, wherein a player provides the plurality of selections.

7. The gaming system of claim 5, wherein the processor generates the plurality of selections.

8. The gaming system of claim 1, wherein before receiving the at least one selection, the processor further receives a selection an input to obtain the plurality of offered award values or a selection an input to obtain a chance to replace at least one of the plurality of offered award values with a new award value.

9. The gaming system of claim 1, wherein the processor further receives at least one second selection of at least one symbol display area associated with one of the plurality of displayed persistent symbols after randomly generating the second plurality of symbols.

10. The gaming system of claim 9, wherein the processor further:
randomly generates a third plurality of symbols for the plurality of symbol display areas, each of the third plurality of symbols being associated with a separate one of the plurality of symbol display areas, where the third plurality of symbols comprises a third plurality of persistent symbols and a third plurality of non-persistent symbols;
display, on the display device, another new persistent symbol in the second selected symbol display area and a subset of the third plurality of symbols, where the third plurality of symbols replaces the displayed second plurality of symbols in the associated symbol display areas without replacing any displayed persistent symbols from the first plurality of symbols or the second plurality of symbols in the associated symbol display areas.

11. The gaming system of claim 1, wherein the processor further:
receives a selection of every symbol display area associated with a displayed persistent symbol, and
removes, from each of the selected symbol display areas, the displayed persistent symbol and offered award value.

12. The gaming system of claim 1, wherein the processor further receives a selection of every symbol display area associated with a displayed persistent symbol that is also associated with award values below a predetermined threshold.

13. The gaming system of claim 1, wherein determining one or more awards based on the values of any of the persistent symbols displayed on the display device comprises:
evaluating one or more currently generated symbols for persistent symbols in one or more symbol display areas of the plurality of symbol display areas that did not have a displayed persistent symbol.

14. A method of operating a gaming system, the method comprising:
randomly generating, using a random number generator, a first plurality of symbols, where the first plurality of symbols comprises a plurality of persistent symbols and a plurality of non-persistent symbols;
displaying, using a display device of the housing, the first plurality of symbols in a plurality of symbol display areas, each of the first plurality of symbols being associated with a separate one of the plurality of symbol display areas;
displaying, using the display device, a plurality of offered award values, where each of the plurality of offered award values is associated with one of the displayed plurality of persistent symbols;
receiving, via an input device, at least one selection of at least one symbol display area associated with one of the plurality of displayed persistent symbols;
removing, from the display device, a displayed persistent symbol and an associated offered award value from the selected symbol display area;
randomly generating, using the random number generator, a second plurality of symbols for the plurality of symbol display areas, each of the second plurality of symbols being associated with a separate one of the plurality of symbol display areas, where the second plurality of symbols comprises a second plurality of persistent symbols and a second plurality of non-persistent symbols;
displaying, using the display device, at least one new persistent symbol in the selected symbol display area and a subset of the second plurality of symbols, where the second plurality of symbols replaces the displayed first plurality of symbols in the associated symbol display areas without replacing any displayed persistent symbols from the first plurality of symbols in the associated symbol display areas;
determining one or more awards based on values of any of the persistent symbols displayed on the display device;
displaying, using the display device, the one or more awards based on the values of any displayed persistent symbols; and
increasing, by the processor, the credit balance by the one or more awards; and
issuing, using a dispenser, a value based on the one or more awards credit balance upon receipt of a cash out signal via a second input device of the gaming system.

15. A non-transitory computer-readable storage medium having machine instructions stored therein, the instructions being executable by a processor to cause the processor to:
randomly generate, using a random number generator, a first plurality of symbols, where the first plurality of symbols comprises a plurality of persistent symbols and a plurality of non-persistent symbols;
display, using a display device of a housing, the first plurality of symbols in a plurality of symbol display areas, each of the first plurality of symbols being associated with a separate one of the plurality of symbol display areas;
display, using the display device, a plurality of offered award values, where each of the plurality of offered award values is associated with one of the displayed plurality of persistent symbols;
receive, via an input device, at least one selection of at least one symbol display area associated with one of the plurality of displayed persistent symbols;
remove, from the display device, a displayed persistent symbol and an associated offered award value from the selected symbol display area;
randomly generate, using the random number generator, a second plurality of symbols for the plurality of symbol display areas, each of the second plurality of symbols being associated with a separate one of the plurality of symbol display areas, where the second plurality of symbols comprises a second plurality of persistent symbols and a second plurality of non-persistent symbols;
display, using the display device, at least one new persistent symbol in the selected symbol display area and a subset of the second plurality of symbols, where the second plurality of symbols replaces the displayed first plurality of symbols in the associated symbol display areas without replacing any displayed persistent symbols from the first plurality of symbols in the associated symbol display areas;
determine one or more awards based on values of any of the persistent symbols displayed on the display device;
display, using the display device, the one or more awards based on the values of any displayed persistent symbols; and
increase the credit balance by the one or more awards; and
issue, using a dispenser, a value based on the one or more awards credit balance upon receipt of a cash out signal via a second input device.
